(19) United States
(12) Patent Application Publication
(10) Pub. No.: US 2024/0176939 A1
(43) Pub. Date: May 30, 2024

(54) VERIFYING THAT A HARDWARE DESIGN FOR A COMPONENT IS PERMUTATION RESPECTING

(71) Applicant: Imagination Technologies Limited, Kings Langley (GB)

(72) Inventors: Faizan Nazar, Hertfordshire (GB); Robert McKemey, Hertfordshire (GB)

(21) Appl. No.: 18/375,466

(22) Filed: Sep. 30, 2023

(30) Foreign Application Priority Data
Sep. 30, 2022 (GB) 2214418.2

(51) Int. Cl. G06F 30/392

(52) U.S. Cl. CPC G06F 30/392

(57) ABSTRACT

A hardware design for a component that implements a permutation respecting function is verified to be permutation respecting for a plurality of input vector permutations over all valid input vectors. For each input vector permutation in the plurality of input vector permutations, it is verified that the hardware design is permutation respecting for the input vector permutation by verifying that (i) an output of an instantiation of the hardware design in response to any input vector in a set of input vectors and (ii) an output of an instantiation of the hardware design in response to the input vector permutation of that input vector, are permutation related. The set of input vectors is selected based on an assumption that the hardware design is permutation respecting for at least one other input vector permutation of the plurality of input vector permutations.

### BACKGROUND

There are many functions which receive an input vector x comprising a plurality of input elements (x₀,x₁, . . . ,xₙ₋₁) and produce permutation related outputs for at least two different orderings (or permutations) of a set of input elements. A function is said to produce permutation related outputs if the function produces a first output in response to a first input vector, and produces a second output in response to a second input vector that is a permutation of the first input vector, and the second output can be deduced solely from the first output and the permutation. Such a function is referred to herein as a permutation respecting function. The set of input vector permutations for which a function is permutation respecting (i.e. produces permutation related outputs for an input vector and the permutation of the input vector) is referred to herein as the set or group of respected input vector permutations. Permutation respecting functions include, but are not limited to, functions F that are invariant with respect to one or more input vector permutations a (i.e. F(σx)=F(x)); functions F that are equivariant with respect to one or more input vector permutations σ (i.e. σF(x =F(σx)); and functions that satisfy t_{σ}(x)=F(σx) wherein the input vector permutation a is mapped to the output transformation t_{σ} by a homomorphism from the group of respected input vector permutations to the automorphism group of the outputs.

An example permutation respecting function is a sorting function Fₛₒᵣₜ(a, b, c) which receives an input vector comprising three input elements a, b, c and outputs a vector comprising the input elements in ascending order. This function is a permutation respecting function because it is invariant with respect to all input vector permutations—i.e. it will produce the same output for any permutation of a set of input elements. For example, the function Fₛₒᵣₜ will output 4, 5, 6 when it receives input elements 4, 5 and 6 in any order. Specifically, the function Fₛₒᵣₜ will output 4, 5, 6 when it receives (i) a=4, b=5 and c=6, (ii) a=4, b=6 and c=5; (iii) a=5, b=4, c=6; (iv) a=5, b=6 and c=4; (v) a=6, b=4, and c=5, or, (vi) a=6, b=5, and c=4. Examples of other permutation respecting functions include, but are not limited to, a mean function that outputs the mean of a plurality of input elements; a median function that outputs the median of a plurality of input elements; a maximum function that outputs the maximum of a plurality of input elements; a minimum function that outputs the minimum of a plurality of input elements; and a function that receives a set of input elements that represent the entries of a square matrix and outputs the determinant of that matrix.

Many electronic devices, such as systems-on-chips (SoCs), include a component that implements a permutation respecting function. Generating a component that implements a permutation respecting function typically includes developing a hardware design that describes the structure and function of an integrated circuit that implements the permutation respecting function; verifying or testing the hardware design to ensure that an integrated circuit manufactured according to the design will behave as expected; and once verified, manufacturing an integrated circuit, at an integrated circuit manufacturing system, in accordance with the hardware design. Verifying the operation, or behaviour, of a hardware design for a component that implements a permutation respecting function comprises verifying that an instantiation of the hardware design produces the correct (or expected) output, according to the function, for all valid input vectors.

A hardware design may be verified, for example, by formal verification or simulation-based verification. Formal verification is a systematic process that uses a mathematical model of the hardware design and mathematical reasoning to verify the hardware design. In contrast, simulation-based verification is a process in which a hardware design is tested by applying stimuli to an instantiation of the hardware design and monitoring the output of the instantiation of the hardware design in response to the stimuli.

Formal verification can improve controllability as compared to simulation-based verification. Low controllability occurs when the number of simulation test signals or vectors required to thoroughly simulate a hardware design becomes unmanageable. For example, a 32-bit comparator requires 2⁶⁴ test vectors. This may take millions of years to verify exhaustively by simulation-based verification. By performing formal verification, the 32-bit comparator can be verified in less than a minute.

While formal verification can be an effective method for exhaustively verifying properties of a hardware design, this is only true if the properties that are to be verified are presented in such a manner that a formal verification tool can solve the mathematical problem presented thereby. Specifically, during formal verification of a hardware design the hardware design is represented as a mathematical model, the properties to be proved are also represented mathematically, and mathematical reasoning is used to determine if the properties are true for the hardware design based on the mathematical model. In other words, in formal verification the verification is presented as a mathematical problem to be solved. Some mathematical problems will be solvable within a reasonable amount of time by a formal verification tool whereas others will not. When a formal verification tool is able to solve the mathematical problem presented by the hardware design and the properties to be verified then the formal verification is said to converge. When, however, a formal verification tool is unable to solve the mathematical problem presented by the hardware design and the properties to be verified, then the formal verification does not converge, and no results are output, and the verification is inconclusive.

The embodiments described below are provided by way of example only and are not limiting of implementations which solve any or all of the disadvantages of known methods and systems for verifying hardware designs for components that implement a permutation respecting function.

### SUMMARY

This summary is provided to introduce a selection of concepts that are further described below in the detailed description. This summary is not intended to identify key features or essential features of the claimed subject matter, nor is it intended to be used to limit the scope of the claimed subject matter.

Described herein are methods and systems for verifying that a hardware design for a component that implements a permutation respecting function is permutation respecting for a plurality of input vector permutations over all valid input vectors. The component is configured to receive an input vector comprising a plurality of input elements and generate an output based on the input vector and the function. The methods include, for each input vector permutation of the plurality of input vector permutations, verifying, at one or more processors, that the hardware design is permutation respecting for the input vector permutation by verifying that (i) an output of an instantiation of the hardware design in response to any input vector in a set of input vectors and (ii) an output of an instantiation of the hardware design in response to the input vector permutation of that input vector, are permutation related. The set of input vectors for each input vector permutation of a subset of the plurality of input vectors permutations is selected based on an assumption that the hardware design is permutation respecting for at least one other input vector permutation of the plurality of input vector permutations.

A first aspect provides a computer-implemented method of verifying that a hardware design for a component that implements a permutation respecting function is permutation respecting for a plurality of input vector permutations over all valid input vectors, the component being configured to receive an input vector comprising a plurality of input elements and generate an output based on the input vector and the function, the method comprising: for each input vector permutation of the plurality of input vector permutations, verifying, at one or more processors, that the hardware design is permutation respecting for the input vector permutation by verifying that (i) an output of an instantiation of the hardware design in response to any input vector in a set of input vectors and (ii) an output of an instantiation of the hardware design in response to the input vector permutation of that input vector, are permutation related; wherein the set of input vectors for each input vector permutation in a subset of the plurality of input vector permutations is selected based on an assumption that the hardware design is permutation respecting for at least one other input vector permutation of the plurality of input vector permutations.

Each assumption that the hardware design is permutation respecting for an input vector permutation may be verified by the verifications.

The method may further comprise identifying the set of input vectors for an input vector permutation of the subset by: identifying a base set of input vectors from the input vector permutation of the subset and the at least one other input vector permutation; identifying a permutation group formed from the input vector permutation of the subset and the at least one other input vector permutation; forming an irreducible set of permutations that comprises the irreducible permutations in the permutation group; and identifying the set of input vectors from the base set of input vectors and the irreducible set of permutations.

Identifying the base set of input vectors may comprise, for each input vector permutation of a set of input vector permutations comprising the input vector permutation of the subset and the at least one other input vector permutation, constraining the base set of input vectors to input vectors in which two input elements have a predetermined relationship.

Each input vector permutation of the plurality of input vector permutation may be an adjacent transposition that transposes two adjacent input elements, and identifying the base set of input vectors may comprise, if an input vector permutation in the set transposes the i^{th} and (i+1)^{th} input elements, constraining the base set of input vectors to input vectors in which the i^{th} and (i+1)^{th} input elements have a predetermined relationship.

The predetermined relationship may be that the i^{th} and (i+1)^{th} input elements are in ascending order or that the i^{th} and (i+1) th input elements are in descending order.

A permutation \tilde{σ} may be deemed to be reducible if (a) there exists a permutation σ′ in the permutation group that is equivalent to σᵥ\tilde{σ} where the length of σ′ is strictly less then the length of σᵥ\tilde{σ} or (b) the length of σᵥ\tilde{σ} is strictly less than the length of \tilde{σ}, wherein σᵥ is the input vector permutation; and deemed irreducible otherwise.

Forming the irreducible set of permutations may comprise determining whether each permutation in the permutation group is irreducible, and, in response to determining that a permutation in the permutation group is irreducible, adding the permutation to the irreducible set of permutations.

Forming the irreducible set of permutations may comprise: (a) determining whether any of the at least one other input vector permutation is irreducible; (b) in response to determining that at least one of the at least one other input vector permutation is irreducible, adding each irreducible input vector permutation in the at least one other input vector permutation to the set of irreducible permutations; (c) adding each of the at least one other input vector permutation to each of the irreducible permutations added to the set of irreducible permutations to generate new permutations, determining if any of the new permutations are irreducible, and adding any new permutations that are irreducible to the set of irreducible permutations; and (d) repeating (c) if any new permutations have been added to the set of irreducible permutations.

Each of the plurality of input vector permutations may be an adjacent transposition that transposes two adjacent input elements; the subset of input vector permutations may comprise the adjacent transposition that transposes the j^{th} and (j +1) th input elements; and the set of input vectors for the transposition that transposes the j^{th} and (j +1) th input elements may not be selected based on an assumption that the hardware design is permutation respecting for the adjacent transposition that transposes the (j +1) th and (j +2) th input element and may not be selected based on assumption that the hardware design is permutation respecting for the adjacent transposition that transposes the (j — 1 th) and j^{th} input elements.

Each of the plurality of input vector permutations may be an adjacent transposition that transposes two adjacent input elements; the subset of input vector permutations may comprise the adjacent transposition that transposes the j^{th} and (j+1)^{th} input elements; and the set of input vectors for the transposition that transposes the j^{th} and (j+1)^{th} input elements may not be selected based on an assumption that the hardware design is permutation respecting for the adjacent transposition that transposes the (j+2)^{th} and (j+3)^{th} input elements and may not be selected based on assumption that the hardware design is permutation respecting for the adjacent transposition that transposes the (j−2^{th}), and (j−1)^{th} input elements.

Each of the plurality of input vector permutations may be an adjacent transposition that transposes two adjacent input elements; the subset of input vector permutations may comprise the adjacent transposition that transposes the j^{th} and (j+1)^{th} input elements; and the set of input vectors for the transposition that transposes the j^{th} and (j+1)^{th} input elements may not be selected based on an assumption that the hardware design is permutation respecting for the adjacent transposition that transposes the (j+1)^{th} and (j+2)^{th} input elements.

Each of the plurality of input vector permutations may be an adjacent transposition that transposes adjacent input elements; the subset of input vector permutations may comprise the adjacent transposition that transposes the j^{th} and (j+1)^{th} input elements; and the set of input vectors for the transposition that transposes the j^{th} and (j+1)^{th} input elements may not be selected based on an assumption that the hardware design is permutation respecting for the adjacent transposition that transposes the (j+1)^{th} and j^{th} input elements.

The subset of input vector permutations may comprise a centre adjacent transposition that transposes the

$${( \frac{n}{2} - 1 )}^{th}$$

input element ana the

$${( \frac{n}{2} )}^{th}$$

input element, ana n is a number of input elements in the input vector.

The plurality of input vector permutations may comprise a generating set of adjacent permutations from which all input vector permutations can be generated, and the set of input vectors for the centre adjacent transposition may be selected based on an assumption that the hardware design is permutation respecting for all or a subset of the other adjacent transpositions in the generating set.

The output of an instantiation of the hardware design in response to a first input vector may be permutation related to the output of the instantiation of the hardware design in response to a permutation of the first input vector if the output of the instantiation of the hardware design in response to the permuted input vector can be deduced solely from the output of the instantiation of the hardware design in response to the first input vector and the permutation.

One or more of the verifications may be performed via formal verification using a formal verification tool.

The method may further comprise outputting one or more signals indicating whether the verifications were successful.

The method may further comprise, in response to determining that at least one verification was not successful, modifying the hardware design.

The method may further comprise, in response to the verifications being successful, encoding on a computer readable storage medium the verified hardware design which, when processed in an integrated circuit manufacturing system, configures the integrated circuit manufacturing system to generate an integrated circuit embodying the design.

The method may further comprise, in response to determining that the one or more verifications were successful, manufacturing, using an integrated circuit manufacturing system, an integrated circuit embodying the component according to the hardware design.

When processed in an integrated circuit manufacturing system, the hardware design for a component that implements a permutation respecting function may configure the integrated circuit manufacturing system to manufacture an integrated circuit embodying the component.

A second aspect provides a computer-implemented method of verifying the correctness of a hardware design for a component that implements a permutation respecting function, the component being configured to receive an input vector comprising a plurality of input elements and generate an output based on the input vector and the function, the method comprising: verifying, at one or more processors, that the hardware design is permutation respecting for a plurality of input vector permutations for all valid input vectors by verifying that the hardware design is permutation respecting for a generating set of input vector permutations for the plurality of input vector permutations in accordance with the first aspect; and verifying, at the one or more processors, that an instantiation of the hardware design generates an expected output for each input vector of a subset of valid input vectors; wherein each valid input vector that is not in the subset of valid input vectors can be obtained by applying one or more of the plurality of input vector permutations to an input vector in the subset.

A third aspect provides a system for verifying a hardware design for a component that implements a permutation respecting function, the system comprising: memory comprising the hardware design for a component that implements a permutation respecting function, the component configured to receive an input vector comprising a plurality of input elements and generate an output based on the input vector and the function, and one or more verification tools; and one or more processors configured to: verify, using at least one of the verification tools, that the hardware design is permutation respecting for a plurality of input vector permutations for all valid input vectors by verifying that the hardware design is permutation respecting for a generating set of input vector permutations for the plurality of input vector permutations in accordance with the method of the first aspect, and verify, using at least one of the verification tools, that an instantiation of the hardware design generates an expected output for each input vector of a subset of valid input vectors, wherein each valid input vector that is not in the subset of valid input vectors can be obtained by applying one or more of the plurality of input vector permutations to an input vector in the subset.

A fourth aspect provides a computer-implemented method of verifying that a hardware design for a component that implements a permutation respecting function is permutation respecting for a plurality of input vector permutations over all valid input vectors, the component being configured to receive an input vector comprising a plurality of input elements and generate an output based on the input vector and the function, the method comprising: for each input vector permutation in a first subset of the plurality of input vector permutations, verifying, at one or more processors, that the hardware design is permutation respecting for that input vector permutation by verifying that (i) an output of an instantiation of the hardware design in response to any input vector in a set of input vectors; and (ii) an output of the instantiation of the hardware design in response to the input vector permutation of the input vector, are premutation related; and, for each input vector permutation in a second subset of the plurality of input vector permutations, verifying, at the one or more processors, that the hardware design is permutation respecting for that input vector permutation by verifying that (i) an output of the instantiation of the hardware design in response to any input vector in a reduced input vector subset, and (ii) an output of the instantiation of the hardware design in response to the input vector permutation of the input vector, are permutation related, the reduced input vector subset for an input vector permutation based on an assumption that the hardware design is permutation respecting for at least one other input vector permutation of the plurality of input vector permutations.

A fifth aspect provides a computer-implemented method of verifying that a hardware design for a component that implements a permutation respecting function is permutation respecting for a plurality of input vector permutations over all valid input vectors, the plurality of input vector permutations comprising one or more transpositions, the component being configured to receive an input vector comprising a plurality of input elements and generate an output based on the input vector and the function, the method comprising: for each input vector permutation of the plurality of input vector permutations, verifying, at one or more processors, that the hardware design is permutation respecting for the input vector permutation by verifying that (i) an output of an instantiation of the hardware design in response to any input vector in a set of input vectors and (ii) an output of an instantiation of the hardware design in response to the input vector permutation of that input vector, are permutation related; wherein the set of input vectors for each input vector permutation in a subset of the plurality of input vector permutations is selected based on an assumption that the hardware design is permutation respecting for at least one other input vector permutation of the plurality of input vector permutations and each of the at least one other input vector permutations is one of the one or more transpositions.

A hardware design for a component that implements a permutation respecting function, when processed in an integrated circuit manufacturing system, may configure the system to manufacture an integrated circuit that embodies the component. There may be provided a non-transitory computer readable storage medium having stored thereon a hardware design for a component that implements a permutation respecting function that, when processed in an integrated circuit manufacturing system, causes the integrated circuit manufacturing system to manufacture an integrated circuit embodying the component.

There may be provided an integrated circuit manufacturing system comprising: a non-transitory computer readable storage medium having stored thereon a hardware design for a component that implements a permutation respecting function; a layout processing system configured to process the hardware design so as to generate a circuit layout description of an integrated circuit embodying the component; and an integrated circuit generation system configured to manufacture an integrated circuit embodying the component according to the circuit layout description.

There may be provided computer program code for performing a method as described herein. There may be provided non-transitory computer readable storage medium having stored thereon computer readable instructions that, when executed at a computer system, cause the computer system to perform the methods as described herein.

The above features may be combined as appropriate, as would be apparent to a skilled person, and may be combined with any of the aspects of the examples described herein.

### BRIEF DESCRIPTION OF THE DRAWINGS

Examples will now be described in detail with reference to the accompanying drawings in which:

FIG. 1 is a block diagram of an example component that implements a permutation respecting function;

FIG. 2 is a schematic diagram that illustrates example input vector permutations and example generating sets based thereon;

FIG. 3 is a flow diagram of an example method for verifying that a hardware design for a component that implements a permutation respecting function is in fact permutation respecting for two or more input vector permutations;

FIG. 4 is a flow diagram of an example method of generating a reduced input vector subset;

FIG. 5 is a schematic diagram illustrating the terms of the irreducible set for an example scenario as a tree;

FIG. 6 is a flow diagram of an example method for verifying the correctness of a hardware design for a component that implements a permutation respecting function using the method of FIG. 3;

FIG. 7 is a block diagram of an example system for verifying that a hardware design for a component that implements a permutation respecting function is in fact permutation respecting for two or more input vector permutations;

FIG. 8 is a block diagram of an example computing-based device;

FIG. 9 is a block diagram of an example computer system in which a component that implements a permutation respecting function may be implemented; and

FIG. 10 is a block diagram of an example integrated circuit manufacturing system for generating an integrated circuit embodying a component that implements a permutation respecting function.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is presented by way of example to enable a person skilled in the art to make and use the invention. The present invention is not limited to the embodiments described herein and various modifications to the disclosed embodiments will be apparent to those skilled in the art. Embodiments are described by way of example only.

While formal verification can provide advantages over simulation-based verification, methods known to the Applicant to formally verify a hardware design for a component that implements a permutation respecting function have proven inefficient (e.g. they take a long time to complete) and/or ineffective (e.g. they are unable to converge, thus they are unable to provide a conclusive answer). For example, one method that is known to the Applicant for formally verifying a hardware design for a component that implements a permutation respecting function comprises formally verifying that an instantiation of the hardware design produces the correct output in response to every valid input vector according to the function. This may be referred to herein as naïve formal verification of a hardware design for a component that implements a permutation respecting function. Such a method has proven inefficient (e.g. proven to take a long time) when the number of input elements is large, and/or ineffective (e.g. unable to converge, or unable to produce a result) when the function is complex. It is noted that the fact that something is known to the Applicant does not mean that it is well known or even known outside the Applicant company.

The Applicant's UK Patent 2572440, which is hereby incorporated by reference in its entirety, describes methods and systems for verifying the correctness of a hardware design for a component that implements a permutation respecting function wherein the verification is broken down into a set of smaller verifications. Specifically, the methods include formally verifying that an instantiation of the hardware design outputs the correct result to the function for a subset of the valid input vectors; and formally verifying that an instantiation of the hardware design is permutation respecting for each of one or more input vector permutations (i.e. that an instantiation of the hardware design produces permutation related outputs for an input vector and the permutation of that input vector). The subset and the input vector permutations are selected so that any input vector that is not in the subset can be generated from an input vector in the subset via a combination of the one or more input vector permutations. The methods described therein have proven to be able to verify a hardware design for a component that implements a permutation respecting function much more quickly than using the naïve method. The methods described therein have also been able to verify hardware designs for which the naïve method was not able to converge (i.e. was not able to provide a definitive answer).

As described above, a permutation respecting function is a function F that receives an input vector x comprising a plurality of input elements (x₀,x₁, . . . ,xₙ₋₁) and produces permutation related outputs for at least two permutations of the same set of input elements. A function produces permutation related outputs if the function produces a first output in response to a first input vector x and a second output in response to a second input vector that is a permutation of the first input vector, and the second output can be deduced solely from the first output and the permutation.

Each input element xᵢ may comprise a single variable or may comprise a plurality of variables (e.g. each input element itself may be a vector or matrix that comprises a plurality of variables). For example, in some cases, each input element may be a b-bit binary number, whereas in other cases each input element may be a vector or a matrix of b-bit binary numbers where b is an integer greater than or equal to 1.

A permutation σ of an input vector x is a permutation (i.e. an ordering) of the input elements xᵢ of the input vector x. Where the input vectors x have n input elements xᵢ there will be n! permutations of an input vector x. For example, an input vector x comprising three input elements (x₀, x₁, x₂) will have 3!=6 permutations (or orderings) σ for a set of input elements {x₀, x₁, x₂} as shown below. The collection of all possible permutations for a set of n input elements will be referred to herein as Sym(n). Accordingly, Sym(n) when n=3 is {σ₀, σ₁, σ₂, σ₃, σ₄, σ₅}.

σ₀(x₀, x₁, x₂)=(x₀, x₁, x₂)

σ₁(x₀, x₁, x₂)=(x₀, x₂, x₁)

σ₂(x₀, x₁, x₂)=(x₁, x₀, x₂)

σ₃(x₀, x₁, x₂)=(x₁, x₂, x₀)

σ₄(x₀, x₁, x₂)=(x₂, x₀, x₁)

σ₅(x₀, x₁, x₂)=(x₂, x₁, x₀)

The notation F(σx) is used to refer to the output of a function F for a permutation σ of the input vector x. For example, where the input vectors comprise three input elements, F(σ₂x) is the output of the function F for an input vector where the order of x₁ and x₂ is swapped or transposed. In other words, F(σ₂x)=F(σ₂(x₀, x₁, x₂))=F((x₀, x₂, x₁)).

As described above, permutation respecting functions include, but are not limited to, functions F that are invariant with respect to one or more input vector permutations σ (i.e. F(σx)=F(x)); functions F that are equivariant with respect to one or more input vector permutations σ (i.e. σF(x)=F(σx)); and, functions that satisfy t_{σ}F(x)=F(σx) wherein the input vector permutation σ is mapped to the output transformation t_{σ} by a homomorphism from the group of respected input vector permutations to the automorphism group of the outputs. As is known to those of skill in the art, an automorphism is an invertible function which maps some set to itself. Where the respected input vector permutations are related by a group homomorphism to output automorphisms, it follows that, if any respected input vector permutations σₐ and σ_{b} are such that σ=σₐσ_{b}, then σ is also respected and t_{σ}=t_{σ}_{ₐ}t_{σ}_{_{b}} since t_{σ}F(x)=F(σx)=F(σx)=F(σₐσ_{b}x)=t_{σ}_{ₐ}F(σ_{b}x)=σₐ_{ₐ}t_{σ}_{_{b}}F(x).

As described above, an example permutation respecting function is a sorting function Fₛₒᵣₜ(x₀,x₁,x₂) which receives an input vector x comprising three input elements x₀, x₁, x₂ and outputs a vector comprising the input elements in ascending order. This function is a permutation respecting function because it is invariant for all input vector permutations—i.e. it will produce the same result or output for any permutation of a set of input elements. For example, the function Fₛₒᵣₜ will output (4, 5, 6) when it receives an input vector comprising 4, 5 and 6 in any order. Another example of a permutation respecting function is an index sorter function H which sorts the input elements and outputs a vector comprising an ordered list of the indices. This function is a permutation respecting function because it is equivariant for all input vector permutations. For example, if such a function receives an input vector with three input elements wherein x₀<x₁<x₂ then the function will output (0, 1, 2) indicating the 0^{th} input element is the smallest input element, the 1^{st} input element is the middle input element, and the 2^{nd} input element is the largest input element. If the order of the input elements changes, then the output will change accordingly. For example, if the order of x₀ and x₁ are swapped, or transposed, then the location of 0 and 1 in the output will change accordingly (i.e. H(x₁,x₀,x₂)==(1,0,2)).

An example of a permutation respecting function that satisfies t_{σ}F(x)=F(σx) is an index function which outputs an index of a particular element (e.g. the index of the maximum element or the minimum element) in the input vector. Such a function may output 0 when the maximum element is the first element and may output 1 when the maximum element is the second element and so on. Another example of a permutation respecting function that satisfies t_{σ}F(x)=F(σx) is h(A, C)=h((a, b), (c, d))=ab−cd because h(A, C)=−h(σₐ(A, C))=−h(C, A) where σₐ swaps, or transposes, the position of the two input elements A and C.

Other example permutation respecting functions include, but are not limited to, mean functions that output the mean of a set of input elements; median functions that output the median of a set of input elements; maximum functions that output the maximum of a set of input elements; minimum functions that output the minimum of a set of input elements; intersection functions that determine the intersection of a set of input elements, such as, functions which determine the intersection of rays or other shapes; search functions which output an indication of whether an element occurs in a set of input elements; counting functions which count the number of times an element appears in a set of input elements; functions which relate to summing or multiplying a set of input elements, such as, functions that find the dot product of a plurality of vectors; functions that find the mean or standard deviation of a set of input elements; and functions where the output is linked to the permutation in a predetermined way.

A permutation respecting function may be permutation respecting for all input vector permutations (i.e. for all σ∈Sym(n)) or it may only be permutation respecting for a subset of input vector permutations (i.e. for some subset of σ∈Sym(n)). For example, a sorting function is permutation respecting for all input vector permutations because it will produce the same output for the same set of input elements regardless of the order of the input elements in the input vector. In other words, a sorting function will produce the same output for any permutation of an input vector x. An example of a function which is only permutation respecting for a subset of the input vector permutations is a dot product: ƒ(a, b, c, d)=ab+cd, which is permutation respecting for the input vector permutation that swaps, or transposes, a and b, the input vector permutation that swaps, or transposes, c and d, and the input vector permutation that swaps a and c, and b and d, but is not permutation respecting for other input vector permutations, such as, the input vector permutation that swaps, or transposes, a and c. Another example of a function that is only permutation respecting for a subset of the input vector permutations is the function g(a, b, c, d)=ad−bc, which calculates the determinant of the 2×2 matrix

$$( \begin{matrix}a & b \\ c & d\end{matrix} ) .$$

An input vector permutation that swaps a and d, or swaps b and c doesn't change the output, but the input vector permutation that swaps a and b, and swaps c and d would negate the output (g(b, a, d, c)=bc−ad=−(ad−bc)=−g(a, b, c, d)), such that t_{(a d)}=t_{(b c)}=the identity map and t_{(a b)(c d)}=negation. The input vector permutations for which a function is permutation respecting (i.e. the function produces permutation related outputs for an input vector and the permutation of the input vector) are referred to herein as the respected input vector permutations E wherein E⊆Sym(n).

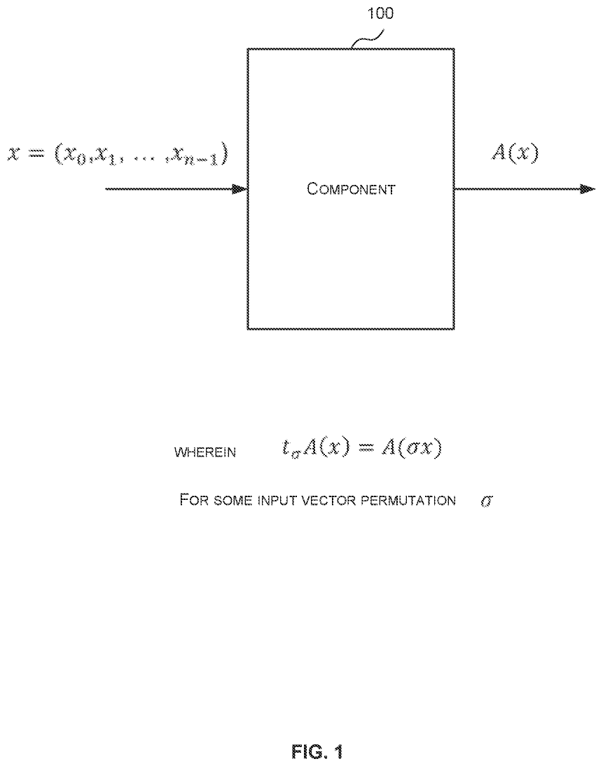

As shown in FIG. 1, a component A 100 that implements a permutation respecting function F comprises hardware logic configured to receive an input vector x, calculate the result F(x) of the permutation respecting function F for the received input vector, and output the calculated result A(x). The notation A(x) is used herein to refer to the output of the component A in response to an input vector x. When the component A is working as expected A(x)=F(x). Similar to the notation F(σx), the notation A(σx) is used herein to refer to the output of the component A in response to a permutation σ of the input vector x. For example, where the input vectors comprise three input elements, A(σ₂x) is the output of the component A in response to an input vector where the order of x₁ and x₂ is swapped. In other words, A(σ₂x)=A(σ₂(x₀, x₁, x₂))=A((x₀, x₂, x₁)).

As described above, the Applicant's UK Patent 2572440 describes a method of verifying the correctness of hardware design for a component that implements a permutation respecting function (i.e. verifying that an instantiation of the hardware design generates the correct output in response to each valid input vector) that takes advantage of the permutation respecting features of the function. The method comprises formally verifying that an instantiation of the hardware design produces the correct result for a subset of the valid input vectors [symbol] ; and formally verifying that the hardware design is permutation respecting for one or more input vector permutations (i.e. produces permutation related outputs in response to any input vector in a set of input vectors and the permutation of the input vector). The subset of valid input vectors and the one or more input vector permutations are selected so that each valid input vector that is not in the subset of valid input vectors can be obtained by applying one or more of the one or more input vector permutations to an input vector in the subset.

As described above, the set of input vector permutations for which the function implemented by the component is permutation respecting is referred to as the respected input vector permutations E, wherein E⊆Sym(n). The one or more input vector permutations that the hardware design is verified to be permutation respecting with respect to are referred to as the relevant input vector permutations R. The relevant input vector permutations R may include all or only a portion of the respected input vector permutations. Accordingly, R⊆E⊆Sym(n).

Verifying that a hardware design is permutation respecting for the relevant input vector permutations R may comprise verifying that, for each relevant input vector permutation σ, an instantiation of the hardware design will produce permutation related outputs for any input vector x in the subset of input vectors [symbol] and for the permutation of that input vector σx. Since there may be up to n! relevant input vector permutations (where n is the number of input elements) the number of input vector permutations to verify may quickly become unmanageable as n increases. For example, when n is 3, n! is equal to 6, however, when n is 8, n! quickly jumps up to 40,320.

Accordingly, where, the relevant input vector permutations form a group, verifying that a hardware design is permutation respecting for the relevant input vector permutations may comprise verifying that an instantiation of the hardware design is permutation respecting for each input vector permutation in a generating set G of the relevant input vector permutations over all input vectors x in the input set X. A generating set G of input vector permutations is a set of input vector permutations ϕᵢ (e.g. G={ϕᵢ|i=1, . . . , m}) from which all of the relevant input vector permutations R can be generated. Accordingly, G⊆R⊆E⊆Sym(n).

In some cases, the generating set G may comprise only adjacent transpositions. A transposition is a permutation in which the position of two elements xᵢ in the n-element input vector is swapped (e.g. element i is swapped with element i+4) and all other elements remain in the same position. An adjacent transposition is a transposition in which the position of two adjacent elements is swapped (e.g. element i is swapped with element i+1). An adjacent transposition which swaps the i^{th} element and the (i+1)^{th} element is denoted σₐₜ₋ᵢ.

σₐₜ₋ᵢx=σₐₜ₋ᵢ(x₀, . . . , xᵢ₋₁, xᵢ, xᵢ₊₁, xᵢ₊₂, . . . , xₙ₋₁)=(x₀, xᵢ₋₁xᵢ₊₁, xᵢ, xᵢ₊₂, . . . , xₙ₋₁)

For example, the permutation σₐₜ₋₀ swaps the 0^{th} element and the 1^{st} element:

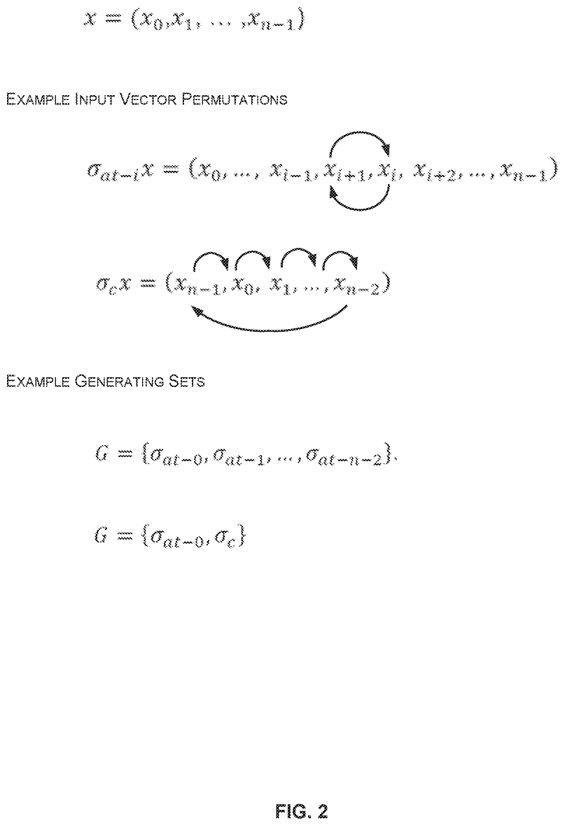

σₐₜ₋₀x=(x₁, x₀, x₂, . . . , xₙ₋₁)

Where the relevant input vector permutations comprise all possible input vector permutations (i.e. R=E=Sym(n)) the generating set G may comprise {σₐₜ₋₀, σₐₜ₋₁, . . . , σₐₜ₋ₙ₋₂} (see, for example, FIG. 2).

In other cases, the generating set G may comprise one or more adjacent transpositions and a cycle permutation. A cycle permutation, which may also be referred to as a cyclic shift, denoted σ_{c}, is the permutation in which every element is moved to the next position and the element in the last position is moved to the first (or 0^{th}) position. In other words, the 0^{th} element moves to the 1^{st} position, the 1^{st} element moves to the 2^{nd} position, and so on, so that the i^{th} element is moved to the (i+1)^{th} position, up to the (n−2)^{th} element which is moved to the (n−1)^{th} position. The (n−1)^{th} element is then moved to the 0^{th} position (see for example, FIG. 2):

σ_{c}x=(xₙ₋₁, x₀, x₁, . . . , xₙ₋₂)

Where the relevant input vector permutations comprise all possible input vector

permutations (i.e. R=E=Sym(n)) the generating set G may comprise {σₐₜ₋₀, σ_{c}} (see, for example, FIG. 2).

Verifying that a hardware design is permutation respecting for an input vector permutation in the generating set for all input vectors x in the input space X may not require explicitly verifying the output for each input vector x in the input space X is permutation related to the output for the permutation thereof. For example, since adjacent transpositions are self-inverse (i.e. σₐₜ₋ᵢ=σₐₜ₋ᵢ⁻¹), verifying that an instantiation of the hardware design is permutation respecting for an adjacent transposition σₐₜ₋ᵢ over the subset of input vectors where xᵢ and xᵢ₊₁ are in ascending order(i.e. xᵢ≤xᵢ₊₁) verifies that the instantiation of the hardware design is permutation respecting for the adjacent transposition over all x in the input space X. This is because if it is proven that A(x)=A(σₐₜ₋ᵢx) for all x where xᵢ≤xᵢ₊₁ then for any input vector x in the input space X, either xᵢ<xᵢ₊₁ meaning it will occur on the left-hand side of the equation, xᵢ>xᵢ₊₁ meaning it will occur on the right-hand side of the equation, or xᵢ=xᵢ₊₁ meaning it will occur on both the left-hand side and the right-hand side of the equation. Reducing the input space in this manner reduces the number of input vectors over which the permutation is verified by a factor of two. Although this may seem like a trivial reduction it can significantly reduce the amount of time to formally verify that an instantiation of a hardware design is permutation respecting for an adjacent transposition. Similar to the above, the verification that A(x)=A(σₐₜ₋ᵢx) could be reduced to the subset of input vectors where xᵢ and xᵢ₊₁ are in descending order.

Testing has shown that it may be more difficult to verify that the hardware design is permutation respecting for some of the input vector permutations in the generating set G than others. An input vector permutation that is difficult to verify may take longer to verify and in some cases the verification may not converge. Which input vector permutations are difficult to verify may depend on which function is implemented by the component and/or how the function is implemented. For example, if the hardware component implements a sorting function, depending on how that sorting function is implemented by the component, proving that the hardware design is permutation respecting for the central transposition (the transposition that swaps the two centre input elements) may be more difficult than proving that the hardware design is permutation respecting for other transpositions. UK Patent 2572440 proposed solving this problem by excluding the difficult to verify input vector permutation(s) from the set of relevant permutations and expanding the subset of input vectors [symbol] to cover those permutation(s).

The inventors have identified that instead of excluding the difficult input vector permutations from the set of relevant permutations and expanding the subset of input vectors [symbol] , the verification of the difficult input vector permutation(s) may be simplified by reducing the input vectors over which the verification is performed based on one or more of the input vector permutations in the generating set having already been verified.

Specifically, verifying that the hardware design is permutation respecting for the relevant input vector permutations R may comprise verifying that an instantiation of the hardware design is permutation respecting for a first subset of input vector permutations in the generating set G for all input vectors (or a subset of input vectors), and verifying that an instantiation of the hardware design is permutation respecting for a second subset of input vector permutations in the generating set G for a reduced input vector subset, wherein the reduced input vector subset is selected based on the knowledge (or an assumption) that it has been successfully verified that the hardware design is permutation respecting for one or more other input vector permutations (the one or more other input vector permutations may be in the first subset or the second subset). As described in more detail below, the input vector permutations in the generating set G may be divided into the first and second subsets in any suitable manner.

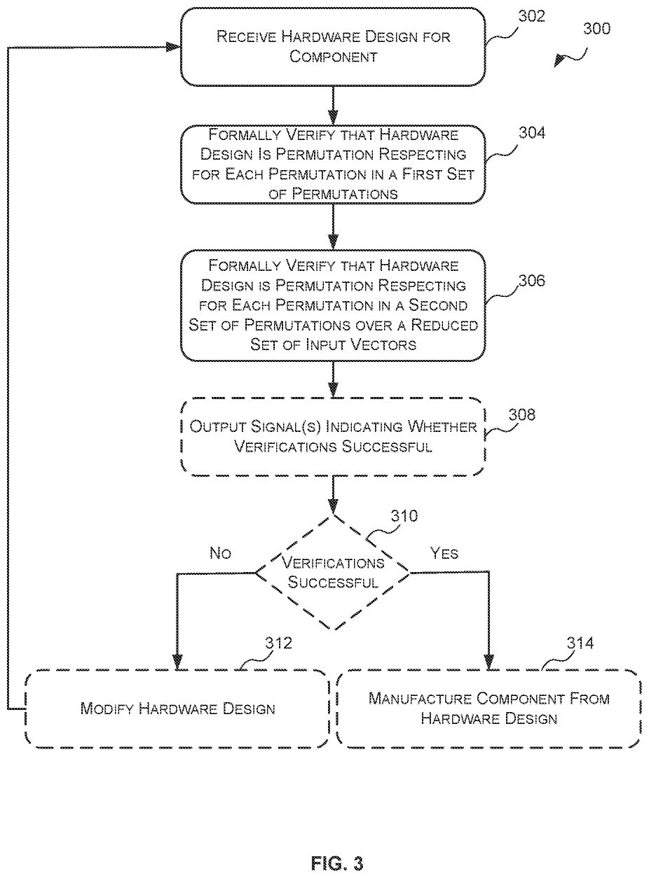

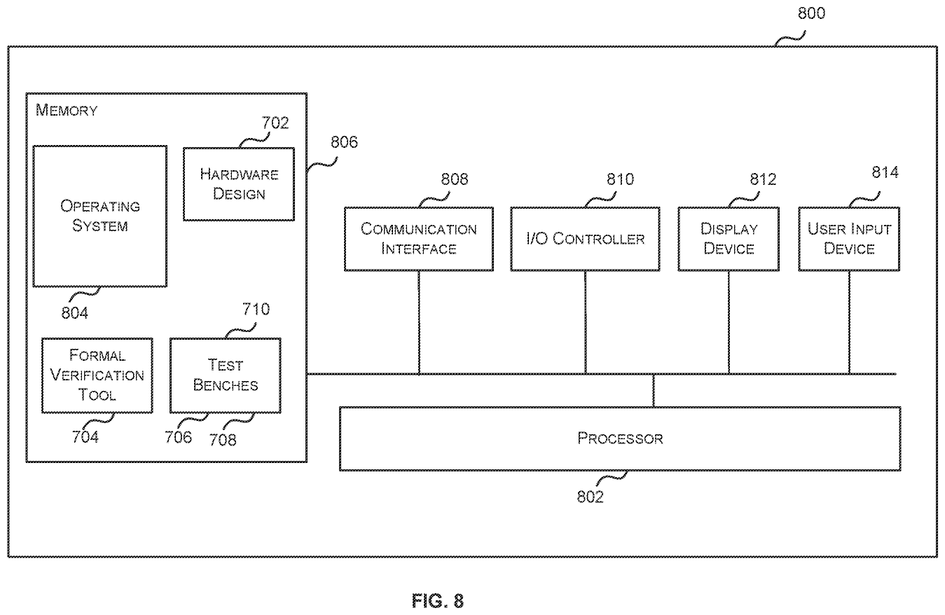

Reference is now made to FIG. 3 which illustrates a method of verifying that a hardware design for a component that implements a permutation respecting function is in fact permutation respecting for a plurality of input vector permutations, wherein the verification of at least one input vector permutation is based on the verification (or assumption) that the hardware design is permutation respecting for another one of the input vector permutations. As described in more detail below, the method 300 may be used to verify that a hardware design for a component that implements a permutation respecting function is in fact permutation respecting for a generating set G of permutations for a set of relevant input vector permutations R. The method 300 may be implemented by a computing-based device such as, but not limited to, the computing-based device 800 described below with respect to FIG. 8. For example, there may be a computer readable storage medium having stored thereon computer readable instructions that, when executed at a computing-based device, cause the computing-based device to perform the method 300 of FIG. 3.

The method 300 begins at block 302 where a hardware design for a component that implements a permutation respecting function is received.

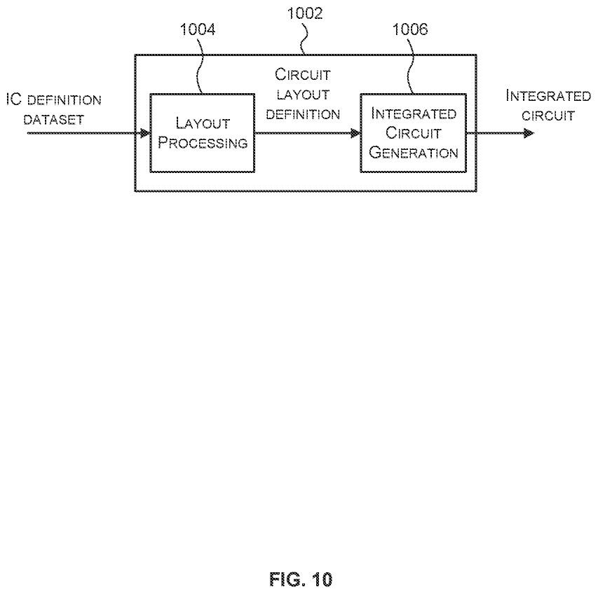

A “hardware design” is a description of the structure and function of an integrated circuit which, when processed at an integrated circuit manufacturing system, causes the integrated circuit manufacturing system to generate an integrated circuit described by the hardware design. For example, as described in more detail below with respect to FIG. 10, when a hardware design is processed at an integrated circuit manufacturing system the integrated circuit manufacturing system may generate the integrated circuit by synthesizing the hardware design into silicon, or, by loading configuration data into a field-programmable gate array (FPGA).

A hardware design may be implemented in a high-level hardware description language (HDL), such as, but not limited to, a register transfer level (RTL) language. Examples of register transfer level languages include, but are not limited to, VHDL (VHSIC Hardware Description Language) and Verilog®. It will be evident to a person of skill in the art that other high-level hardware description languages may be used such as proprietary high-level hardware description languages.

An “instantiation of a hardware design” is a representation of the hardware and/or functionality of the hardware defined by the hardware design. An instantiation of a hardware design includes, but is not limited to, an emulation model of the integrated circuit hardware design that simulates the behaviour of the hardware defined by the hardware design, a synthesized version (e.g. netlist) of the hardware design, a hardware implementation (e.g. integrated circuit or a field-programmable gate array (FPGA)) of the hardware design, and a mathematical model of the hardware design generated by a formal verification tool. An instantiation of the hardware design embodies the hardware design in a form which can be tested to verify the hardware design.

A hardware design for a component that implements a permutation respecting function F is thus a description of the structure and function of an integrated circuit that is configured to receive an input vector x comprising a plurality (i.e. n) of input elements, calculate the result F(x) of the permutation respecting function F for the received input vector, and output the calculated result. Processing a hardware design for a component that implements a permutation respecting function at an integrated circuit manufacturing system causes the integrated circuit manufacturing system to generate an integrated circuit that embodies the component.

Once the hardware design for the component that implements a permutation respecting function has been received, the method 300 proceeds to block 304.

At block 304, for each input vector permutation in a first subset of the plurality of input vector permutations to be verified, it is verified that the hardware design is permutation respecting for that input vector permutation for all input vectors x in the input space X by formally verifying that an instantiation of the hardware design generates permutation related outputs for an input vector and the input vector permutation of that input vector for a set of input vectors K. The set of input vectors K that are verified are sufficient to verify that the hardware design is permutation respecting for all input vectors x in the input space X. The set of input vectors K may include all of the input vectors or only a subset of the input vectors in the input space X.

For example, as described above, since adjacent transpositions are self-inverse (i.e. σₐₜ₋ᵢ=σₐₜ₋ᵢ⁻¹), verifying that an instantiation of the hardware design is permutation respecting for an adjacent transposition σₐₜ₋ᵢ over the subset of input vectors where xᵢ and xᵢ₊₁ are in ascending order (i.e. xᵢ≤xᵢ₊₁) verifies that the instantiation of the hardware design is permutation respecting for the adjacent transposition over all x in the input space X.

As described above, formal verification is a systematic process that uses mathematical reasoning to verify a property of a hardware design. In contrast, simulation-based verification is a process in which a hardware design is tested by applying stimuli to the hardware design and monitoring the output of the hardware design in response to the stimuli.

Formally verifying that an instantiation of the hardware design will produce permutation related outputs in response to any input vector in a set of input vectors and the permutation of that input vector may comprise generating a test bench in a formal verification language comprising one or more assertions to be verified and optionally one or more constraints (e.g. assumptions) and/or modelling logic; linking the test bench to the hardware design; and formally verifying, using a formal verification tool, that the one or more assertions are true (or hold) for the hardware design under the constraints, and outputting one or more signals indicating whether the one or more assertions were successfully verified.

Formal verification languages include, but are not limited to, SystemVerilog Assertions (SVA), Property Specification Language (PSL), Incisive® Assertion Library (IAL), Synopsys® OpenVera™ Assertions (OVA), Symbolic Trajectory Evaluation (STE), Hardware Property Language (HPL), 0-In®, and Open Verification Library (OVL). While traditional hardware description languages (HDL), such an RTL language, have the ability to capture individual cycle behaviour, they are too detailed to describe properties at a higher level. In contrast, formal verification languages can capture design behaviour spread across multiple hardware design cycles (e.g. clock cycles) in a concise, unambiguous manner.

As is known to those of skill in the art, a formal assertion is a statement or expression that a particular property is expected to hold for a hardware design (i.e. is always true). An assertion of the form “assert property [evaluable expression]” is said to “assert” the property specified by the “evaluable expression”. If an asserted property (e.g. the evaluable expression) is evaluated to be false for the hardware design for any valid input, the hardware design is not behaving as expected and there is likely an error. For example, in the example assertion “assert property a=b”; if a is not equal to b at any point then the hardware design is not behaving as expected and there is an error.

Constraints may be implemented via one or more formal assumption or assume statements. As is known to those of skill in the art of formal verification, an assumption statement in, or related to, a component imposes a constraint on the operation of that component. Assumption statements can be used to constraint the space over which a formal verification is performed. For example, an assumption statement may be used to restrict the input vectors to be verified to a subset of valid input vectors.

The test bench (including the one or more assertions and any conditions (e.g. assumptions)) may be linked to the hardware design by incorporating the test bench into the hardware design or binding the test bench to the hardware design. Specifically, the test bench may be bound to the relevant signals of the hardware design to determine when an instantiation of the hardware design has received an input vector and what the corresponding output is.

Once the test bench has been linked to the hardware design, the hardware design, the test bench, and the bindings (if there are bindings) are loaded into a formal verification tool and the formal verification tool is configured to verify that the one or more assertions are true for the hardware design under any specified constraints.

A formal verification tool is a software tool that is capable of performing formal verification of a hardware design. Formal verification tools include, but are not limited to, formal model checkers (which also may be referred to as formal property checkers) which are configured to formally verify a property of an integrated circuit hardware design; and formal equivalence checkers which are configured to formally verify the equivalence of two designs (e.g. two integrated circuit hardware designs, or an integrated circuit hardware design and a netlist etc.). Examples of formal model checkers include, but are not limited to, OneSpin 360® DV, Mentor Graphics Questa® Formal Verification, Synopsys® VC Formal, Cadence® Incisive® Enterprise Verifier, and JasperGold®. Examples of formal equivalence checkers include, but are not limited to Synopsys® HECTOR, JasperGold® Sequential Equivalence Checking (SEC) App, and other logical equivalence checkers (LECs) and sequential logical equivalence checkers (SLECs).

In formal verification the hardware design (e.g. the hardware design for a component that implements a permutation respecting function) is transformed into a mathematical model (e.g. a state-transition system, or a flow graph) to thereby provide an instantiation of the hardware design which can be tested to verify the hardware design, and the formal properties to be verified (e.g. the asserted properties) are expressed using mathematical logic using a precise syntax or a language with a precise mathematical syntax and semantics.

A formal verification tool verifies an assertion by searching the entire reachable state space of the instantiation of the hardware design (e.g. state-transition system, or flow graph) without explicitly traversing all the states to determine if there is a valid state of the instantiation of the hardware design (as defined by formal constraints) in which the asserted property is not true. The search is done by, for example, encoding the states using efficient Boolean encodings using Binary decision diagrams (BDDS), or using advanced SAT (satisfiability-based bounded model checking) based techniques. In some cases, tools can be used to implement techniques, such as, but not limited to, abstraction, symmetry, symbolic indexing, and invariants to improve performance and achieve scalability. Since formal verification of an assertion algorithmically and exhaustively explores all valid input values over time, verifying a property in this manner allows a property to be exhaustively proved or disproved for all valid states.

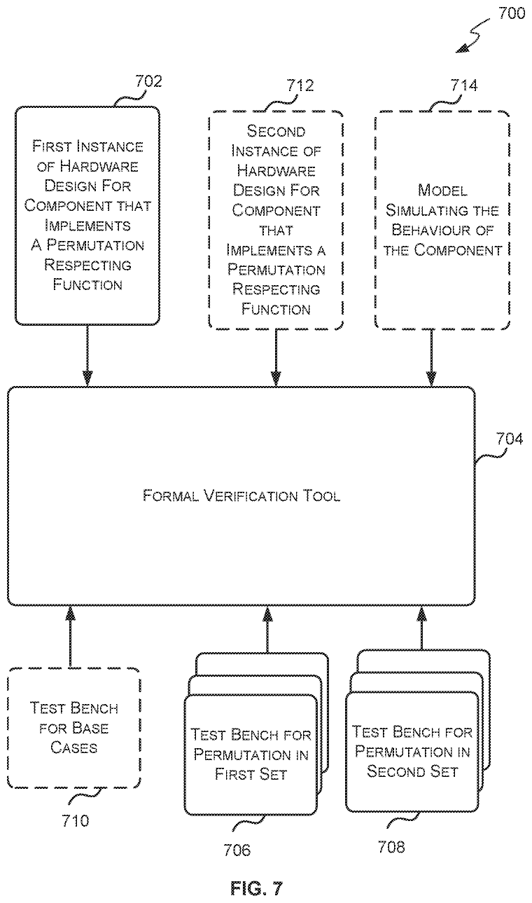

An example test bench which may be used to verify that a hardware design generates permutation related outputs for an input vector permutation for a set of input vectors K is described below with respect to FIG. 7.

Once verification that the hardware design is permutation respecting for each input vector permutation in the first subset has been performed, the method 300 proceeds to block 306.

At block 306, for each input vector permutation in a second subset of the plurality of input vector permutations to be verified, it is verified that the hardware design is permutation respecting for that input vector permutation for all input vectors x in the input space X by formally verifying that an instantiation of the hardware design generates permutation related outputs for an input vector and the input vector permutation of that input vector for a reduced input vector subset S, wherein the reduced input vector subset S is selected based on the knowledge (or assumption) that it has been verified that the hardware design is permutation respecting for one or more other input vector permutations. In other words, the input vectors over which an input vector permutation of the second subset is verified is reduced based on the knowledge (or assumption) that the hardware design is permutation respecting with respect to at least one other input vector permutation.

The other input vector permutations may comprise input vector permutations in the first subset and/or second subset. For example, in some cases, block 306 may be iterative where, for example, a first input vector permutation in the second subset is verified for a reduced input vector subset based on the verifications performed in block 304, then a second input vector permutation in the second subset is verified for a reduced input vector subset that is based on the verifications performed in block 304 and the verification of the first input vector permutation in the second subset and so on. In other cases, block 306 may not be iterative, and any input vector permutation in the second subset may only take into account the verification of the input vector permutations in the first subset. In yet other cases, a combination of the two previous cases may be implemented. For example, the reduced input vector subsets for two input vector permutations in the second subset may be based on the verifications in block 304, then the reduced input vector subsets for two more input vector permutations in the second subset may be based on the verifications in block 304 and the verifications of the first two input vector permutations in the second subset.

The reduced input vector permutation subset S for an input vector permutation is generally selected to eliminate input vectors for which it has already been verified by the verification of one or more other input vector permutations that the hardware design is permutation respecting for that input vector permutation. Example methods of selecting the reduced input vector subset S are described below. The reduced input vector subset S for an input vector permutation is smaller than the smallest set of input vectors K that could be used to verify that input vector permutation in block 304.

Formally verifying that an instantiation of the hardware design will produce permutation related outputs in response to any input vector in a reduced input vector subset S and the permutation of that input vector may comprise generating a test bench in a formal verification language comprising one or more assertions to be verified and optionally one or more constraints (e.g. assumptions) and/or modelling logic; linking the test bench to the hardware design; and formally verifying, using a formal verification tool, that the one or more assertions are true (or hold) for the hardware design under the constraints, and outputting one or more signals indicating whether the one or more assertions were successfully verified. An example test bench is described below with respect to FIG. 7.

The plurality of input vector permutations to be verified may be divided into the first and second subsets in any suitable manner. Generally, those input vector permutations for which it is more difficult (in terms of time and/or formal verification convergence) to verify that the hardware design is permutation respecting for may be placed in the second subset, and those input vector permutations for which it is easier (in terms of time and/or formal verification convergence) to verify that the hardware design is permutation respecting for may be placed in the first subset. The input vector permutations which are easier or harder to verify may be dependent on one or more factors, such as the function that is implemented, how the function is implemented in the component, and the number and/or size of the input elements. For example, as described above, where the plurality of input vector permutations comprises a set of adjacent transpositions and the component implements a sorting function, it may be more difficult in some cases, to verify the centre adjacent transposition than any of the other adjacent transpositions. In this example, all of the other adjacent transpositions may be placed in the first subset and the centre adjacent transposition may be placed in the second subset.

Once verification that the hardware design is permutation respecting for each input vector permutation in the second subset of input vector permutations has been performed the method 300 may end or the method may proceed to block 308 or block 310.

At block 308, the formal verification tool used to perform the verification may output one or more signals that indicates whether the verifications were successful. For example, when the formal verification tool is used to verify an assertion, the formal verification tool may output a signal that indicates whether or not the assertion is true (i.e. the asserted property is true for all valid states or sequence of states of the hardware design), which may also be referred to herein as the assertion being successfully verified. The output may be yes, the assertion is valid or has been successfully verified; no, the assertion is not valid (i.e. it is not true or has failed for at least one valid state or sequence of states) or has not been successfully verified; or the formal verification was inconclusive. The formal verification may be inconclusive, for example, because the computing-device running the formal verification tool has run out of memory or because the formal verification tool has determined that a certain amount of progress has not been made after a predefined period of time.

Where an assertion is not valid or has not been successfully verified the formal verification tool may also output information indicating a state or a sequence of states of the hardware design which cause the assertion to fail (i.e. a counter-example). For example, the formal verification tool may output a trace of the verification indicating at what point, state or sequence of states the failure occurred. Once a signal has been output indicating whether the verifications were successful the method 300 may end or the method 300 may proceed to block 310.

At block 310, a determination is made as to whether the verifications performed in blocks 304 and 306 were successful. Where block 310 is preceded by block 308, then the determination may be made based on the output signal(s). If it is determined that the verifications were successful, indicating that an instantiation of the hardware design is permutation respecting for the plurality of input vector permutations, then the method 300 may end or the method 300 may proceed to block 314 where the verified hardware design is encoded on a computer readable medium which, when processed in an integrated circuit manufacturing system, configures the integrated circuit manufacturing system to generate an integrated circuit embodying the design and/or the component defined by the hardware design may be implemented in hardware. If, however, it is determined that at least one of the verifications was not successful, indicating that an instantiation of the hardware design will not behave correctly for all input vectors in the input space, then the method 300 may proceed to block 312 where the hardware design is modified to correct an error in the hardware design that caused the unexpected behaviour. In some cases, the information indicating a state or sequence of states of the hardware design which caused an assertion to fail (i.e. a counter-example) may be used to modify the hardware design. Once the hardware design has been modified, the modified hardware design may be re-verified (e.g. blocks 302-310 may be repeated for the modified hardware design).

Although in the example method 300 of FIG. 3, blocks 304 and 306 are executed sequentially, in other examples they may be executed in the reverse order (e.g. block 306 may be executed before block 304) and/or they may be executed in parallel. In particular, if block 306 is performed before the result of block 304 is known, block 306 may assume a successful verification result for block 304. That is because, in the cases where that assumption is incorrect, the verification will fail anyway at block 310 due to the block 304 verification being unsuccessful.

Although in the example method 300 of FIG. 3 the verifications described with respect to blocks 304 and 306 are completed via formal verification, in other examples the verifications may be completed via other suitable verification methods. For example, alternatively one or more of the verifications described with respect to blocks 304 and 306 may be implemented via simulation-based verification.

### Examples Where the First and Second Subsets of Input Vector Permutations Comprise Adjacent Transpositions

The following examples describe how the characteristics of transpositions, and group properties, can be used to identify the reduced input vector subset S for an input vector permutation in the second subset.

As described above, to verify that a hardware design for a component A that receives an n-element input vector x is permutation invariant for an adjacent transposition σₐₜ₋ᵢ (i.e. a transposition that swaps the i^{th} and i+1^{th} input elements of the input vector) for all input vectors x in the input space X, you only need to verify that the hardware design is permutation invariant for the input vectors x in a subset [symbol] ᵢ. The subset [symbol] ᵢ may comprise input vectors x wherein xᵢ and xᵢ₊₁ are in ascending order (i.e. [symbol] ᵢ={x∈X|xᵢ≤xᵢ₊₁}) (which may be referred to as the ascending order property); or the subset [symbol] ᵢ may comprise input vectors x in the input space X wherein xᵢ and xᵢ₊₁ are in descending order (i.e. [symbol] ᵢ={x∈X|xᵢ≥xᵢ₊₁}) (which may be referred to as the descending order property). In other words, verifying A(σₐₜ₋ᵢx)=A(x) for all x∈ [symbol] ᵢ is equivalent to verifying that A(σₐₜ₋ᵢx)=A(x) for all x∈X. In many of the examples below, the ascending order property will be used, but it will be evident to a person of skill in the art that alternatively the descending order property may be used.

Once it has been verified (e.g. in block 304 of the method 300 of FIG. 3 or in block 306 of the method 300 of FIG. 3) that a hardware design is permutation invariant with respect to an adjacent transposition of the input vector, the ascending order property (or the descending order property) used above to reduce the input space over which the adjacent transposition is verified can be used to further reduce the input space over which other adjacent transpositions are verified.

Specifically, to verify that a hardware design is permutation invariant for an adjacent transposition σₐₜ₋ᵢ for all input vectors x in the input space X (i.e. all x∈X) after it has been verified that the hardware design is permutation invariant for an adjacent transposition σₐₜ₋ⱼ it is sufficient to verify that the hardware design is permutation invariant for all input vectors x in the subset [symbol] _{i, j} as defined below, wherein i, j=0,1, . . . , n−1 and i≠j.

$${i , j}_{} = \{ \begin{matrix}\{ x ∈ X \vert {x}_{i} \leq {x}_{i + 1} , {x}_{i} \leq {x}_{i + 2} \} , & if j = i + 1 \\ \{ x ∈ X \vert {x}_{i - 1} \leq {x}_{i + 1} , {x}_{i} \leq {x}_{i + 1} \} , & if j = i - 1 \\ {i}_{} ⋂ {j}_{} , & otherwise\end{matrix}$$

When |i−j|=1, [symbol] _{i, j} can alternatively be expressed as shown below. In general ( [symbol] ᵢ∩ [symbol] ⱼ)⊆ [symbol] _{i, j}⊂ [symbol] ᵢ and [symbol] _{i, j}≠ [symbol] _{j,i} when |i−j|=1.

Accordingly, if it has been verified that a hardware design is permutation invariant with respect to an adjacent transposition σₐₜ₋ⱼ, verifying A(σₐₜ₋ᵢx)=A(x) for all x∈ [symbol] _{i, j} is equivalent to verifying A(σₐₜ₋ᵢx)=A(x) for all x∈ [symbol] ᵢ, which is equivalent to verifying that A(σₐₜ₋ᵢx)=A(x) for all x∈X, wherein i, j=0,1, . . . , n−1 and i≠j.

This can be proved mathematically. Specifically, let [symbol] _{w}= [symbol] ᵢ∩ [symbol] ⱼ. If |i−j|>1 then σₐₜ₋ⱼ and σₐₜ₋ᵢ commute—i.e. σₐₜ₋ⱼσₐₜ₋ᵢ is equal to σₐₜ₋ᵢσₐₜ₋ⱼ—and [symbol] _{w}= [symbol] _{i, j}. [symbol] ᵢ can then be decomposed to [symbol] _{w}∪σₐₜ₋ⱼ [symbol] _{w}. If we have proved that A(σₐₜ₋ᵢx)=A(x) for all x∈ [symbol] _{i, j} then we have proved that A(σₐₜ₋ᵢx)=A(x) for all x∈ [symbol] _{w} since [symbol] _{i, j}= [symbol] _{w}. For x∈σₐₜ₋ⱼ [symbol] _{w}, x=σₐₜ₋ⱼx′ for x′∈ [symbol] _{w} hence:

A(σₐₜ₋ᵢx)=A(σₐₜ₋ᵢσₐₜ₋ⱼx′)=A(σₐₜ₋ⱼσₐₜ₋ᵢx′)=A(σₐₜ₋ᵢx′)=A(x′)=A(σₐₜ₋ⱼx)=A(x)

Therefore, when |i−j|>1, if we have proved that A(σₐₜ₋ᵢx)=A(x) for all x∈ [symbol] _{i, j} then we have proved A(σₐₜ₋ᵢx)=A(x) for all x∈ [symbol] ᵢ, which we already know is equivalent to verifying A(σₐₜ₋ᵢx)=A(x) for all x∈X.

If |i−j|=1, [symbol] ᵢ can be decomposed to [symbol] _{w}∪σₐₜ₋ⱼ [symbol] _{w}∪σₐₜ₋ⱼσₐₜ₋ᵢ [symbol] _{w}. For x∈ [symbol] _{w}∪σₐₜ₋ⱼ [symbol] _{w}, if we have proved that A(σₐₜ₋ᵢx)=A(x) for all x∈ [symbol] _{i, j} we have proved that A(σₐₜ₋ᵢx)=A(x) for all x∈ [symbol] _{w}∪σₐₜ₋ⱼ [symbol] _{w}. For x∈σₐₜ₋ⱼσₐₜ₋ᵢ [symbol] _{w}, x=σₐₜ₋ⱼσₐₜ₋ᵢx′ for x′∈ [symbol] _{w}. Since σₐₜ₋ⱼσₐₜ₋ᵢσₐₜ₋ⱼ=σₐₜ₋ᵢσₐₜ₋ⱼσₐₜ₋ᵢ it can be deduced that:

A(σₐₜ₋ᵢx)=A(σₐₜ₋ᵢσₐₜ₋ⱼσₐₜ₋ᵢx′)=A(σₐₜ₋ⱼσₐₜ₋ᵢσₐₜ₋ⱼx′)=A(σₐₜ₋ᵢσₐₜ₋ⱼx′)=A(x′)=A(σₐₜ₋ᵢx)=A(σₐₜ₋ⱼσₐₜ₋ᵢx′)=A(x)

Therefore, when |i−j|=1, if we have proved that A(σₐₜ₋ᵢx)=A(x) for all x∈ [symbol] _{i, j} then we have proved A(σₐₜ₋ᵢx)=A(x) for all x∈ [symbol] _{I}, which we already know is equivalent to verifying A(σ_{AT-I}X)=A(x) for all x∈X.

It can be seen from the above that the more complicated adjacent transpositions to take into account when determining the reduced input vector subset [symbol] _{i, j} for an adjacent transposition σₐₜ₋ᵢ are the adjacent transpositions σₐₜ₋ᵢ₊₁ and σₐₜ₋ᵢ₋₁. This is because when |i−j|=1 the transpositions do not commute—i.e. σₐₜ₋ⱼσₐₜ₋ᵢ is not equal to σₐₜ₋ᵢσₐₜ₋ⱼ.

An example is now provided to illustrate that [symbol] _{i, j}≠ [symbol] ᵢ∩ [symbol] ⱼ when |i−j|=1. In this example, n=3, i=1, j=0. Let the function implemented by the component A receive an input vector x=(x₀, x₁, x₂), wherein x₀, x₁, x₂ are 0 or 1, and output x₀ x₁ x̅₂̅ wherein x̅₂̅ denotes (binary) NOT x₂. It is evident that A(σₐₜ₋₀x)=A(x) for all x∈X—i.e. swapping the first two elements of the input vector does not affect the output of the function implemented by the component. It is also evident that A(1,1,0)=1≠0=A(1,0,1) so A(σₐₜ₋₁x)≠A(x) for all x∈X. However, A(σₐₜ₋₁x)=A(x) for all x∈X in [symbol] ₀∩ [symbol] ₁, because that intersection requires x₀≤x₁≤x₂, which only includes vectors with a zero as the first element and a vector in which all elements are 1 (for all of which the function will always evaluate to zero, irrespective of a transposition of the second and third elements). Therefore verifying (σₐₜ₋ᵢx)=A(x) for all x∈X in [symbol] ᵢ∩ [symbol] ⱼ is not sufficient to prove A(σₐₜ₋ᵢx)=A(x) for all x∈X.

This same principal can be extended to take into account the fact that it has been verified that the hardware design is permutation invariant for more than one adjacent transposition. In other words, the same principal can be extended to generate a further reduced subset for verifying an adjacent transposition when more than one adjacent transposition has already been verified.

Specifically, in general, to verify that a hardware design is permutation invariant for an adjacent transposition σₐₜ₋ᵢ after it has been verified that the hardware design is permutation invariant for adjacent transpositions σₐₜ₋ⱼ_{₁}, . . . , σₐₜ₋ⱼ_{ₘ} wherein i, j₁, . . . jₘ∈{0, 1, . . . , n−1}, the inventors have identified that it is sufficient to verify that the hardware design is permutation invariant for σₐₜ₋ᵢ for all input vectors x in a reduced input vector subset S=∪σ [symbol] ₛ for all permutations σ in the irreducible set I (i.e. S=∪_{σ∈I}σ [symbol] ₛ), wherein [symbol] ₛ= [symbol] ᵢ∩ [symbol] ⱼ_{₁} . . . ∩ [symbol] ⱼ_{ₘ} and I is a specifically chosen subset of the permutations σ in the permutation group W:= [symbol] σₐₜ₋ᵢ,σₐₜ₋ⱼ_{₁}, . . . , σₐₜ₋ⱼ_{ₘ} [symbol] . Specifically, the irreducible set I comprises the permutations in the permutation group W that cannot be reduced.

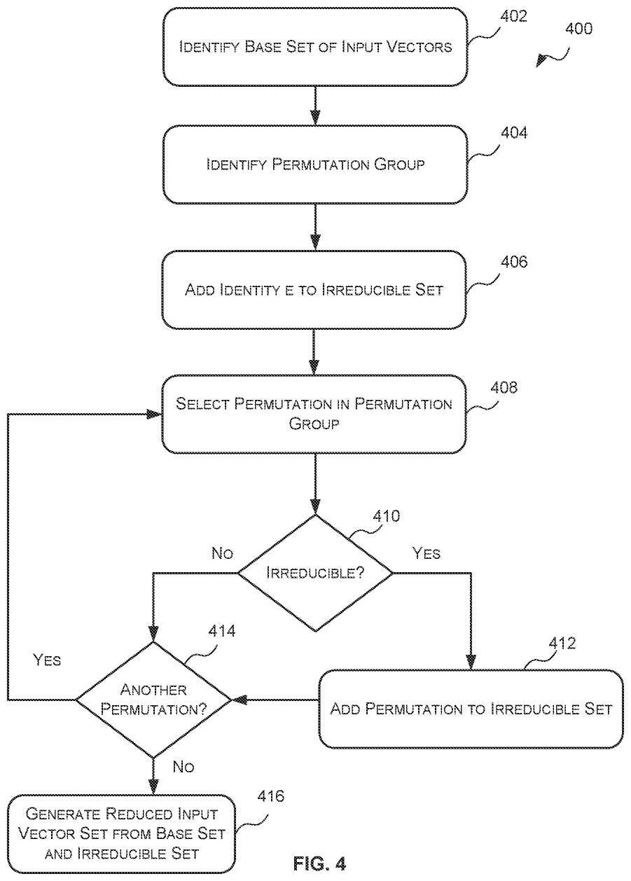

Reference is now made to FIG. 4 which illustrates an example method 400 for identifying the reduced input vector subset S. The reduced input vector subset S is the smallest set of input vectors which can be used to verify that a hardware design is permutation invariant with respect to an adjacent transposition σₐₜ₋ᵢ for all input vectors x in the input space X, based on the assumption that a hardware design is permutation invariant for adjacent transpositions σₐₜ₋ⱼ_{₁}, . . . , σₐₜ₋ⱼ_{ₘ}.

The method 400 begins at block 402 where a base set of input vectors [symbol] ₛ is identified based on the adjacent transposition to be verified (σₐₜ₋ᵢ) and the adjacent transpositions that have been verified (σₐₜ₋ⱼ_{₁}, . . . , σₐₜ₋ⱼ_{ₘ}). The base set of input vectors [symbol] ₛ comprises input vectors x in the input space X in which two or more of the input elements x are in a particular order (e.g. ascending order or descending order). Which input elements are in the particular order are determined from the adjacent transposition to be verified (σₐₜ₋ᵢ) and the adjacent transpositions that have been verified (σₐₜ₋ⱼ_{₁}, . . . , σₐₜ₋ⱼ_{ₘ}).

In the examples described herein, for each adjacent transposition of the adjacent transposition to be verified (σₐₜ₋ᵢ) and the adjacent transpositions that have been verified (σₐₜ₋ⱼ_{₁}, . . . , σₐₜ₋ⱼ_{ₘ}), the input vectors in the base set of input vectors [symbol] ₛ is limited to those input vectors in which two of the input elements are in the particular order. Specifically, for each of these adjacent transpositions, the base set of input vectors [symbol] ₛ is limited or restricted to input vectors in which the k^{th} and (k+1)^{th} input elements are in the particular order where the k^{th} and (k+1)^{th} input elements are swapped by the adjacent transposition. For example, for the adjacent transposition σₐₜ₋₂ which swaps input elements 2 and 3, the base set of input vectors [symbol] ₛ would be limited to those input vectors wherein input elements 2 and 3 are in the particular order.

Where the set of input vectors in which the k^{th} and (k+1)^{th} input elements are in the particular order (e.g. ascending order or descending order) is denoted [symbol] ₖ, the base set of input vectors [symbol] ₛ can be represented as [symbol] ₛ= [symbol] ᵢ∩ [symbol] ⱼ_{₁} . . . ∩ [symbol] ⱼ_{ₘ}. For example, [symbol] ₛ= [symbol] ₀∩ [symbol] ₂ specifies that the base set of input vectors comprises the input vectors in the input space in which input element 0 (x₀) and input element 1 (x₁) are in the particular order (e.g. x₀≤x₁), and input element 2 (x₂) and input element 3 (x₃) are in the particular order (e.g. x₂≤x₃). Once the base set of input vectors [symbol] ₛ has been identified, the method 400 proceeds to block 404.

At block 404, a permutation group W that is formed from the set comprising the adjacent permutation to be verified (σₐₜ₋ᵢ) and the verified input vector permutations (σₐₜ₋ⱼ_{₁}, . . . , σₐₜ₋ⱼ_{ₘ}) is identified (i.e. W:= [symbol] σₐₜ₋ᵢ, σₐₜ₋ⱼ_{₁}, . . . , σₐₜ₋ⱼ_{ₘ} [symbol] ). A permutation group is a finite group whose elements are permutations of a given set and whose group operation is composition of permutations in the permutation group. Accordingly, each permutation in the permutation group W can be written as a product of σₐₜ₋ᵢ, σₐₜ₋ⱼ_{₁}, . . . , σₐₜ₋ⱼ_{ₘ}. Once the permutation group W has been identified, the method 400 proceeds to block 406.

At block 406, the irreducible set I is initialised to comprise the identity element e (i.e. I={e}). As described above, the irreducible set I comprises the permutations in the permutation group W that are irreducible. The method 400 then proceeds to block 408.

At block 408, a permutation \tilde{σ} in the permutation group W that has not yet been analysed is selected. Once a permutation \tilde{σ} in the permutation group W has been selected, the method 400 proceeds to block 410.

At block 410, it is determined whether the selected permutation \tilde{σ} is irreducible with respect to the permutations in W. A permutation \tilde{σ} is deemed to be reducible if: (a) there exists a permutation σ′ in W that is equivalent to σₐₜ₋ᵢ\tilde{σ} where the length of σ′ is strictly less than the length of σₐₜ₋ᵢ\tilde{σ}; or (b) if the length of σₐₜ₋ᵢ\tilde{σ} is strictly less than the length of \tilde{σ}. Two permutations σ and σ′ in W are said to be equivalent if, by group identities on W, A(σx)=A(σ′x) for all x in [symbol] ₛ or A(σx)=A(σₐₜ₋ⱼ_{ₖ}σ′x), where σₐₜ₋ⱼ_{ₖ} is one of σₐₜ₋ᵢ, σₐₜ₋ⱼ_{₁}, . . . , σₐₜ₋ⱼ_{ₘ}. If it is determined that a is equivalent to b, then b is equivalent to a; and if a is equivalent to b and b is equivalent to c, then a is equivalent to c. As described above, each permutation σ in W can be written as a product of σₐₜ₋ᵢ, σₐₜ₋ⱼ_{₁}, . . . , σₐₜ₋ⱼ_{ₘ}. The length of a permutation σ in W is the smallest number of products that can be used to represent σ. If neither (a) nor (b) is satisfied, then the permutation \tilde{σ} is irreducible.

If it is determined that the selected permutation \tilde{σ} is irreducible, then the method 400 proceeds to block 412 where the selected permutation it is added to the irreducible set I. The method 400 then proceeds to block 414. If, however, it is determined that the selected permutation it is reducible then the method 400 proceeds directly to block 414.

At block 414 it is determined whether there are any more permutations in W that have not yet been analysed. If there is at least one permutation in W that has not yet been analysed, then the method 400 proceeds back to block 408 where one of the permutations in W that has not been analysed is selected. If, however, there are no more permutations in W that have not been analysed then the method 400 proceeds to block 416.

At block 416, the reduced input vector subset S is identified. In the examples described herein the reduced input vector subset S is determined to be σBₛ for all permutations σ in I, wherein [symbol] ₛ= [symbol] ᵢ∩ [symbol] ⱼ_{₁} . . . ∩ [symbol] ⱼ_{ₘ}. For example, to verify that the hardware design is permutation invariant for an adjacent transposition σₐₜ₋ⱼ, after it has been verified that the hardware design is permutation invariant for σₐₜ₋ⱼ, and I={e, σₐₜ₋ⱼ}, then the reduced input vector subset is S= [symbol] ₛ∪σₐₜ₋ⱼ [symbol] ₛ and [symbol] ₛ= [symbol] ᵢ∩ [symbol] ⱼ. Once S has been determined or identified, the method 400 ends.

### CALCULATING S—EXAMPLE 1

An example of calculating S in accordance with the method 400 of FIG. 4 for a first example scenario is now described. In the example scenario it has been verified that the hardware design is permutation invariant for the adjacent transposition σₐₜ₋ⱼ and we want to verify that the hardware design is permutation invariant for the adjacent transposition σₐₜ₋ᵢ. Therefore, in this example, [symbol] ₛ= [symbol] ᵢ∩ [symbol] ⱼ and W= [symbol] σₐₜ₋ᵢ, σₐₜ₋ⱼ [symbol] .

If |i−j|>1, then σₐₜ₋ᵢσₐₜ₋ⱼ=σₐₜ₋ⱼσₐₜ₋ᵢ, so W={e, σₐₜ₋ᵢ, σₐₜ₋ⱼ, σₐₜ₋ᵢσₐₜ₋ⱼ}. To determine the irreducible set I in W, I is initialised to include e (i.e. I={e}). If it is assumed that A(σₐₜ₋ᵢx′)=A(x′) for all x′ in [symbol] ₛ then, as shown below, for all x′ in [symbol] ₛ σₐₜ₋ᵢ, σₐₜ₋ⱼ, σₐₜ₋ᵢσₐₜ₋ⱼ are all reducible so I={e} and S=e [symbol] ₛ= [symbol] ₛ.

A(σₐₜ₋ᵢσₐₜ₋ᵢx′)=A(x′)=A(σₐₜ₋ᵢx′)

A(σₐₜ₋ᵢσₐₜ₋ⱼx′)=A(σₐₜ₋ⱼσₐₜ₋ᵢx′)=A(σₐₜ₋ⱼx′)

A(σₐₜ₋ᵢσₐₜ₋ᵢσₐₜ₋ⱼx′)=A(σₐₜ₋ⱼx′)=A(x′)=A(σₐₜ₋ᵢσₐₜ₋ⱼx′)

If, however, |i−j|=1, then W={e, σₐₜ₋ᵢ, σₐₜ₋ⱼ, σₐₜ₋ᵢσₐₜ₋ⱼ, σₐₜ₋ⱼσₐₜ₋ᵢ, σₐₜ₋ᵢσₐₜ₋ⱼσₐₜ₋ᵢ}. To determine the irreducible set I in W, I is initialised to include e (i.e. I={e}). If it is assumed that for all input vectors x′ in [symbol] ₛ that A(σₐₜ₋ᵢx′)=A(x′), for all x′ in [symbol] ₛ, all of the permutations in W are reducible as shown below, except σₐₜ₋ⱼ since σₐₜ₋ᵢ and σₐₜ₋ⱼ do not commute. Therefore I={e, σₐₜ₋ⱼ} and S=e [symbol] ₛ∪σₐₜ₋ⱼ [symbol] ₛ= [symbol] ₛ∪σₐₜ₋ⱼ [symbol] ₛ.

A(σₐₜ₋ᵢσₐₜ₋ⱼσₐₜ₋ᵢx′)=A(σₐₜ₋ⱼσₐₜ₋ᵢσₐₜ₋ⱼx′)=A(σₐₜ₋ᵢσₐₜ₋ⱼx′)=A(σₐₜ₋ⱼx′)=F(x′)=A(σₐₜ₋ᵢx′)=A(σₐₜ₋ⱼσₐₜ₋ᵢx)

A(σₐₜ₋ᵢσₐₜ₋ᵢσₐₜ₋ⱼσₐₜ₋ᵢx′)=A(σₐₜ₋ⱼσₐₜ₋ᵢx′)=A(σₐₜ₋ᵢσₐₜ₋ⱼσₐₜ₋ᵢx′)

This paragraph and the previous paragraph are consistent with what was described above and show that the method 400 works if the invariance for a single adjacent transposition has been verified.

### CALCULATING S—EXAMPLE 2

An example of calculating S in accordance with the method 400 of FIG. 4 for a second example scenario is now described. In the example scenario it has been verified that the hardware design is permutation invariant for the adjacent transpositions σₐₜ₋ⱼ_{₁} and σₐₜ₋ⱼ_{₂}, and we want to verify that the hardware design is permutation invariant for the adjacent transposition σₐₜ₋ᵢ. Therefore, in this example, [symbol] ₛ= [symbol] ᵢ∩ [symbol] ⱼ_{₁}∩ [symbol] ⱼ_{₂} and W= [symbol] σₐₜ₋ᵢ, σₐₜ₋ⱼ_{₁}, σₐₜ₋ⱼ_{₂} [symbol] . Since σₐₜ₋ₐ and σ_{at-b} commute (i.e. σₐₜ₋ₐσ_{at-b}=σ_{at-b}σₐₜ₋ₐ) only when |a−b|>1 or a=b, in this example the relevant positions of i, j₁, j₂ are important and thus I will vary with the relevant position of i, j₁, j₂. Following the method 400 of FIG. 4, S is as follows where σ_{at-q} has been shown as σ_{q} for simplicity.

$$S = \{ \begin{matrix}{s}_{} & if \vert {j}_{1} - i \vert , \vert {j}_{2} - i \vert > 1 \\ {i , {j}_{1}}_{} ⋂ {{j}_{2}}_{} & if \vert {j}_{1} - i \vert = 1 , \vert {j}_{2} - i \vert , \vert {j}_{1} - {j}_{2} \vert > 1 \\ {i , {j}_{2}}_{} ⋂ {{j}_{1}}_{} & if \vert {j}_{1} - i \vert , \vert {j}_{1} - {j}_{2} \vert > 1 , \vert {j}_{2} - i \vert = 1 \\ {s}_{} ⋃ {σ}_{i - 1} {s}_{} ⋃ {σ}_{i - 1} {σ}_{i - 2} {s}_{} & if \{ {j}_{1} , {j}_{2} \} = \{ i - 1 , i - 2 \} \\ {s}_{} ⋃ {σ}_{i + 1} {s}_{} ⋃ {σ}_{i + 1} {σ}_{i + 2} {s}_{} & if \{ {j}_{1} , {j}_{2} \} = \{ i + 1 , i + 2 \} \\ {s}_{} ⋃ {σ}_{i - 1} {s}_{} ⋃ {σ}_{i + 1} {s}_{} ⋃ {σ}_{i - 1} {σ}_{i + 1} {s}_{} ⋃ {σ}_{i - 1} {σ}_{i + 1} {σ}_{i} {s}_{} & if \{ {j}_{1} , {j}_{2} \} = \{ i - 1 , i + 1 \}\end{matrix}$$

### CALCULATING S—EXAMPLE 3

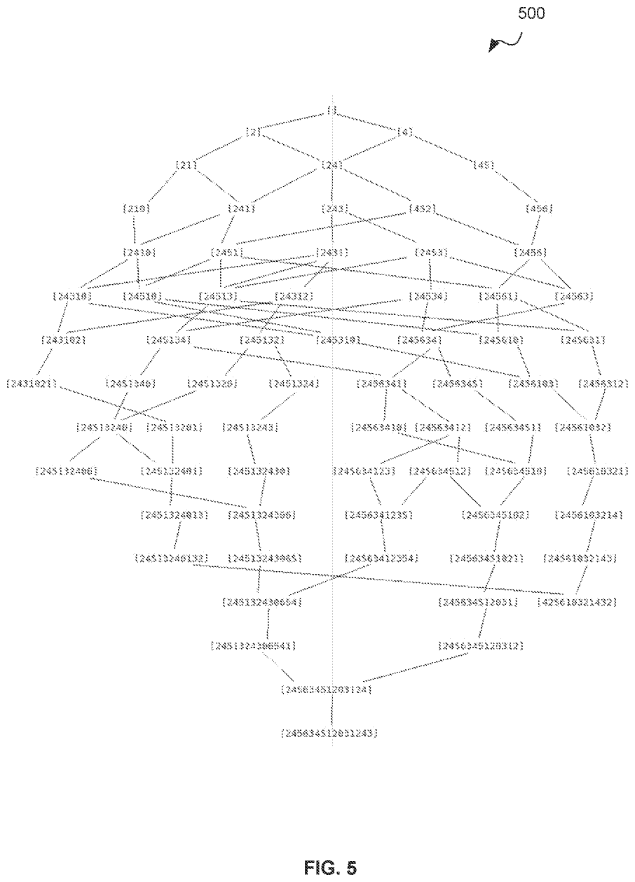

Reference is now made to FIG. 5 which illustrates an irreducible set I 500 as a tree for an example scenario where the input vector x comprises eight elements (i.e. n=8) and it has been verified that the hardware design is permutation invariant for all the adjacent transpositions in a generating set G={σₐₜ₋₀, σₐₜ₋₁, σₐₜ₋₂, σₐₜ₋₃, σₐₜ₋₄, σₐₜ₋₅, σₐₜ₋₆} except the centre transposition σₐₜ₋₃ and now we want to verify that the hardware design is permutation respecting for the centre transposition σₐₜ₋₃. Therefore in this example W= [symbol] σₐₜ₋₀, σₐₜ₋₁, σₐₜ₋₂, σₐₜ₋₃, σₐₜ₋₄, σₐₜ₋₅, σₐₜ₋₆ [symbol] and [symbol] ₛ= [symbol] ₀∩ [symbol] ₁∩ [symbol] ₂∩ [symbol] ₃∩ [symbol] ₄∩ [symbol] ₅∩ [symbol] ₆. Where [symbol] ᵢ is generated according to the ascending rule then [symbol] ₛ comprises input vectors x where the elements are in ascending order. Where [symbol] ᵢ is generated according to the descending rule then [symbol] ₛ comprises input vectors x where the elements are in descending order.

In FIG. 5 “[ab]” means adjacent transposition σ_{at-b} followed by adjacent transposition σₐₜ₋ₐ. For example [24]=σₐₜ₋₂σₐₜ₋₄. It can be seen that the tree comprises 69 permutations thus the irreducible set I comprises 69 permutations, and the reduced subset of input vectors S comprises 69 terms. Specifically, S= [symbol] ₛ∪σₐₜ₋₂ [symbol] ₛ∪σₐₜ₋₄ [symbol] ₛ . . . . Therefore the reduced subset of input vectors S comprises 69*(number of input vectors in [symbol] ₛ) input vectors.

It can similarly be shown that when n=16, to verify the centre adjacent transposition σₐₜ₋₇ the reduced subset of input vectors S comprises 12,869 terms. Accordingly, as n increases, generating the reduced set of input vectors S becomes more complex.

Since the number of permutations in W increases exponentially with n, it may not to be efficient in some cases to calculate the irreducible set I, and thus the reduced set of input vectors S, in accordance with the method 400 of FIG. 4—i.e. by determining all the permutations in W and then determining one by one whether each permutation in W is irreducible. Instead a tree approach, as shown in FIG. 5, may be used. In this approach, only permutations which are generated from irreducible permutations are analysed by adding an adjacent transposition to the previous irreducible permutation and determining if that is irreducible. Specifically, one starts with the known irreducible adjacent transpositions. To determine the reduced input vector set S for an adjacent transposition σₐₜ₋ᵢ the known irreducible adjacent transpositions are σₐₜ₋ᵢ₋₁ and σₐₜ₋ᵢ₊₁. For example, in FIG. 5, the known irreducible transpositions for the central transposition σₐₜ₋₃ are σₐₜ₋₂ (shown as [2]) and σₐₜ₋₄ (shown as [4]). Once the known irreducible adjacent transpositions are determined then adjacent transpositions are added to a previous irreducible permutations to generate a new permutation and then it is determined if that new permutation is irreducible. Once you have identified another irreducible permutation this is repeated until no more irreducible permutations are identified.

### Simplifying the Calculation of S

The smallest reduced input vector subset S to verify the invariance of a hardware design for an adjacent transposition can be obtained by taking into account all of the permutations that have been verified (i.e. the permutations for which it has been verified that the hardware design is permutation invariant). However, as described above, depending on the size of n, calculating the absolute smallest reduced input vector subset can be complicated and time consuming. Accordingly, in some cases, it may be more efficient to only take into account a subset of the verified permutations such that the reduced input vector subset is larger, but simpler to identify. In general, it is the adjacent transpositions closest to the adjacent transposition to be verified that add the most complexity in determining the reduced input vector subset. The adjacent transpositions closest to the adjacent transposition to be verified include σₐₜ₋ᵢ₋₁, σₐₜ₋ᵢ₋₂, σₐₜ₋ᵢ₊₁, σₐₜ₋ᵢ₊₂. where σₐₜ₋ᵢ is the adjacent transposition to be verified.

In a first alternate example, if the adjacent transpositions on either side of the adjacent transposition to be verified have been verified, they are not taken into account in determining the reduced input vector subset S₁. It is noted that this reduced input vector subset, which may be referred to as a partially reduced input vector subset, is denoted S₁ to distinguish it from the reduced input vector subset S which is determined based on all verified permutations. For example, if σₐₜ₋ᵢ is the adjacent transposition to be verified then the verification of adjacent transpositions σₐₜ₋ᵢ₋₁ and σₐₜ₋ᵢ₊₁ are not taken into account in determining the reduced input vector subset S₁. For the example shown in FIG. 5, this removes all of the terms in the tree that comprise a 2 or a 4, which is all of the terms except the [ ] or e term. Where all of the other adjacent transposition have been verified (i.e. all adjacent transpositions in the generating set G={σₐₜ₋₀, . . . , σₐₜ₋ₙ₋₂} except σₐₜ₋ᵢ) and the ascending property is used, the reduced input vector subset S₁ comprises all input vectors x in the input space X wherein x₀≤x₁≤ . . . ≤xᵢ₋₁ AND xᵢ₊₂≤ . . . ≤xₙ₋₁.

In a second alternative example, if the adjacent transpositions two above and two below the adjacent transposition to be verified have been verified, they are not taken into account in determining the reduced input vector subset S₂. For example, if σₐₜ₋ᵢ is the adjacent transposition to be verified, then the verification of adjacent transpositions σₐₜ₋ᵢ₋₂ and σₐₜ₋ᵢ₊₂ are not taken into account in determining the reduced input vector subset S₂. For the example shown in FIG. 5, this removes all of the terms in the tree that comprise a 1 or a 5, which only leaves terms [ ], [2], [4], [24] and [243]. Where all of the other adjacent transposition have been verified (i.e. all adjacent transpositions in the generating set G={σₐₜ₋₀, . . . , σₐₜ₋ₙ₋₂} except σₐₜ₋ᵢ) and the ascending property is used, the reduced input vector subset S₂ comprises all input vectors x in the input space X wherein x₀≤x₁ . . . ≤xᵢ₋₂ AND xᵢ₊₃≤xᵢ₊₂≤ . . . ≤xₙ₋₁. Accordingly, this results in a reduced input vector subset that is centred around the transposition being verified.

In a third alternative example, if the adjacent transposition one above the adjacent transposition to be verified has been verified, it is not taken into account in determining the reduced input vector subset S₃ₐ. For example, if σₐₜ₋ᵢ is the adjacent transposition to be verified then the verification of adjacent transposition σₐₜ₋ᵢ₊₁ is not taken into account in determining the reduced input vector subset S₃ₐ. For the example shown in FIG. 5, this removes all of the terms in the tree that comprise a 4, which only leaves terms [ ], [2], [21], and [210] down one side of the tree. Where all of the other adjacent transpositions have been verified (i.e. all adjacent transposition in the generating set G={σₐₜ₋₀, . . . , σₐₜ₋ₙ₋₂} except σₐₜ₋ᵢ) and the ascending property is used, the reduced input vector subset S₃ₐ comprises all input vectors x in the input space X wherein xᵢ₊₂≤ . . . ≤xₙ₋₁.

In a fourth alternative example, which is a variant of the third alternative example, if the adjacent transposition one below the adjacent transposition to be verified has been verified, it is not taken into account in determining the reduced input vector subset S_{3b}. For example, if σₐₜ₋ᵢ is the adjacent transposition to be verified then the verification of adjacent transposition σₐₜ₋ᵢ₋₁ is not taken into account in determining the reduced input vector subset S_{3b}. For the example shown in FIG. 5, this removes all of the terms in the tree that comprise a 2, which only leaves terms [ ], [4], [45], and [456] down one side of the tree. Where all of the other adjacent transpositions have been verified (i.e. all adjacent transpositions in the generating set G={σₐₜ₋₀, . . . , σₐₜ₋ₙ₋₂} except σₐₜ₋ᵢ) and the ascending property is used, the reduced input vector subset S_{3b} comprises all input vectors x in the input space X wherein x₀≤ . . . ≤xᵢ₋₁.

Accordingly, in all of the alternative examples it is much easier to identify the reduced input vector subset.

Table 1 below shows the estimated reduction in the input vector space for each of the alternative examples described above where n is the number of elements in the input vector x.

TABLE 1

| | $Estimated Size Reduction - \frac{\vert X \vert}{\vert S \vert}$ |
|---|---|
| S₁ | ${[ ( \frac{n}{2} - 1 ) ! ]}^{2}$ |
| S₂ | $\frac{{4 ! [ ( \frac{n}{2} - 2 ) ! ]}^{2}}{5}$ |
| S₃ₐ | ${[ ( \frac{n}{2} - 1 ) ! ]}^{2} ( \frac{n}{2} + 1 )$ |
| S_{3b} | ${[ ( \frac{n}{2} - 1 ) ! ]}^{2} ( \frac{n}{2} + 1 )$ |
| S | ${[ ( \frac{n}{2} - 1 ) ! ( \frac{n}{2} + 1 ) ]}^{2}$ |

From the estimates in Table 1 it can be seen that S will be the smallest (i.e. the best/most reduction), then S₃ₐ and S_{3b}, then S₁ and then S₂ (i.e. the worst/least reduction).

### Test Results

Table 2 below shows the min, median and max time taken (in seconds) to formally verify that the hardware design for a first component A1 and the hardware design for a second component A3 are permutation invariant for the centre adjacent transposition over (i) all input vectors x in the input space X; (ii) all input vectors x in the reduced input vector space S₁; (iii) all input vectors x in the reduced input vector space S₂; and (iii) all input vectors x in the reduced input vector space S₃ₐ. Components A1 and A3 each implemented a sorting function which receives an input vector x comprising n input elements x₀ to xₙ₋₁ and outputs a vector in which the input elements are in ascending order. Each input element is m bits. A1 and A3 implemented odd-even-merge sorters, which work by sorting subsets of the inputs and then merging the subsets together and sorting them again. A1 and A3 differed in the comparison method. A ‘-’ in Table 2 indicates that the verification did not converge, or the verification was inconclusive.

TABLE 2

| | A1 | | | | | | | | | | | | |
|---|---|---|---|---|---|---|---|---|---|---|---|---|---|
| | or | X | | | S₁ | | | S₂ | | | S₃ₐ | | |
| n, m | A3 | Min | Med | Max | Min | Med | Max | Min | Med | Max | Min | Med | Max |
| 4, 4 | A1 | 6 | 6 | 7 | 4 | 6 | 6 | 5 | 6 | 7 | 5 | 5 | 5 |
| | A3 | 6 | 7 | 7 | 5 | 5 | 6 | 5 | 7 | 7 | 5 | 5 | 6 |
| 4, 8 | A1 | 5 | 6 | 6 | 5 | 6 | 6 | 5 | 5 | 6 | 5 | 5 | 6 |
| | A3 | 5 | 5 | 5 | 5 | 5 | 5 | 5 | 6 | 6 | 5 | 5 | 6 |
| 8, 4 | A1 | 207 | 209 | 254 | 69 | 72 | 80 | 89 | 100 | 115 | 11 | 12 | 12 |
| | A3 | 197 | 201 | 202 | 62 | 65 | 67 | 90 | 96 | 104 | 14 | 14 | 16 |
| 8, 8 | A1 | 17131 | 17663 | 17852 | 847 | 885 | 942 | 2397 | 2624 | 3066 | 115 | 127 | 135 |
| | A3 | 8145 | 8278 | 9019 | 934 | 968 | 1400 | 1575 | 1875 | 1876 | 160 | 172 | 214 |
| 8, 16 | A1 | — | — | — | 9789 | 10550 | 12017 | 22225 | 22609 | 25293 | 1239 | 1296 | 1326 |
| | A3 | — | — | — | 15527 | 15872 | 17401 | 8969 | 9527 | 10137 | 1594 | 1621 | 1869 |
| 16, 4 | A1 | — | — | — | 3306 | 3495 | 3620 | — | — | — | 265 | 271 | 293 |
| | A3 | — | — | — | 2747 | 2954 | 3076 | — | — | — | 253 | 255 | 272 |

It can be seen that, not surprisingly, using the reduced input vector subset S₂ provided the least improvement over using the full input space X, and using the reduced input vector subset S₃ₐ provided the best improvement over using the full input space X.

Table 3 below shows example times taken to formally verify that the hardware design for the first component A1 is permutation invariant for the central adjacent transposition over (i) all input vectors x in the input space X under an assumption that it has been verified that the hardware design is permutation respecting for all other adjacent transpositions; (ii) all input vectors x in the reduced input vector space S₃ₐ under an assumption that it has been verified that the hardware design is permutation respecting for all other adjacent transpositions; (iii) all input vectors x in the reduced input vector space S₃ₐ; and (iii) all x in the reduced input vector space S. A ‘-’ in Table 3 indicates that the verification did not converge, or the verification was inconclusive.

TABLE 3

| | | S₃ₐ + | | |
|---|---|---|---|---|
| | X + permutation | permutation | | |
| | respecting | respecting | | |
| n, m | assumptions | assumptions | S₃ₐ | S |
| 8, 4 | 490 | 23 | 13 | 14 |
| 8, 8 | 13927 | 174 | 150 | 158 |
| 8, 16 | — | 2643 | 975 | 665 |
| 8, 32 | — | — | 12983 | 1743 |
| 16, 4 | — | 273 | 254 | 1677-16000 |
| 16, 8 | — | — | 12972 | — |
| 16, 16 | — | — | — | — |

It can be seen from Table 3 that simply assuming that the hardware design is permutation respecting with respect to the other adjacent transpositions does not perform as well as reducing the input vector space. It can also be seen from Table 3 that using the fully reduced input space S can improve the convergence and processing time for some values of n and m, but not others. For example, using the fully reduced input vector subset S provides improvements over using the partially reduced input vector subset in some cases, but not others. Specifically, it provides the best results when n=8 and m is large (16 or 32) but does not provide any improvement when n is larger (e.g. 16). Accordingly, it may be advantageous in some cases to use a partially reduced input vector subset.

### Application to Other Permutations

Although the examples above relate to verifying that a hardware design is permutation invariant for an adjacent transposition after it has been verified that the hardware design is permutation respecting for one or more other adjacent transpositions, the methods above are not limited to verifying adjacent transpositions and can be equally applied to other types of permutations. For example, the method 400 of FIG. 4 can also be applied to identify a reduced input vector subset to verify that a hardware design is permutation respecting for a cycle permutation (also referred to as a cyclic shift) after it has been verified that the hardware design is permutation respecting for one or more adjacent transpositions.

For example, if it has been verified that a hardware design, for a component that implements a permutation invariant function in which the input vector has three input elements x₀, x₁, x₂ (i.e. n=3), is permutation invariant for the adjacent transposition σₐₜ₋₀ and we want to verify that the hardware design is permutation invariant for the cycle permutation σ_{c}, then [symbol] ₛ includes all input vectors x wherein x₀≤x₂≤x₂ and W= [symbol] σ_{c}, σₐₜ₋₀ [symbol] . All of the permutations in W are irreducible except σₐₜ₋₀ therefore the irreducible set I comprises e and σₐₜ₋₀ (i.e. I={e, σₐₜ₋₀}), and the reduced input vector subset S is thus [symbol] ₛ∪σₐₜ₋₀ [symbol] ₛ.

The larger n gets, the more complicated the calculation of S for a cycle permutation becomes.

In the above examples, the number of input vectors that are tested to verify a hardware design is invariant are reduced based on already verified (or assumed verified) adjacent transpositions. However, it will be evident to a person of skill in the art that the method could be equally applied if the already verified (or assumed verified) permutations are other transpositions. In other words, the described method is not limited to the already verified (or assumed verified) permutations being adjacent transpositions.

### Application to Permutation Respecting Functions Generally

Although the examples above relate to verifying the permutation invariance of a hardware design with respect to a permutation, it will be evident to a person of skill in the art that the methods described above are not limited to verifying the permutation invariance of a hardware design but can be used to verify that a hardware design is permutation respecting.

Specifically, suppose a function ƒ is invariant with respect to transformation functions t_{σ}. In general, for some permutations satisfying σσ′≠σ′σ, it may be that t_{σ}t_{σ′}≠t_{σ′}t_{σ}. This means that the order in which transformation functions are applied cannot simply be swapped.

In a simple example ƒ(x)=x. In this example ƒ(σx)=σx=t_{σ}ƒ(x), so t_{σ}=σ, the permutation operation. In this case, whenever σσ′≠σ′σ then t_{σ}t_{σ′}≠t_{σ′}t_{σ}

The methods of determining a reduced input vector subset S to verify that a hardware design is invariant with respect to an adjacent transposition described above can also be used to determine a reduced input vector subset to verify that a hardware design for a component that implements ƒ(x), or a similar function, is permutation respecting for a permutation. This will be described below by way of example.

Specifically, in an example, the hardware design is for a component that implements ƒ(x) wherein the input vector x is a 4-element vector (i.e. n=4). All of the adjacent transpositions in the generating set G={σₐₜ₋₀, σₐₜ₋₁, σₐₜ₋₂} except the centre adjacent transposition σₐₜ₋₁ have been verified (i.e. it has been verified that the hardware design is permutation respecting for σₐₜ₋₀ and σₐₜ₋₂. Accordingly, [symbol] ₛ= [symbol] ₀∩ [symbol] ₁∩ [symbol] ₂ and W= [symbol] σₐₜ₋₀, σₐₜ₋₁, σₐₜ₋₂ [symbol] . According to the example described above, the irreducible set I comprises e, σₐₜ₋₀, σₐₜ₋ₙ₋₂, σₐₜ₋₀σₐₜ₋ₙ₋₂, σₐₜ₋₀σₐₜ₋ₙ₋₂σₐₜ₋₁ thus the irreducible set I does not comprise σₐₜ₋₀σₐₜ₋₁.

To prove that σₐₜ₋₀σₐₜ₋₁ is reducible it is assumed that ƒ(σₐₜ₋₁σₐₜ₋₀x)=t_{σ}_{ₐₜ₋₁}ƒ(σₐₜ₋₀x) and ƒ(σₐₜ₋₁x)=t_{σ}_{ₐₜ₋₁}ƒ(x). As above, it is also assumed ƒ(σₐₜ₋₀x)=t_{σ}_{ₐₜ₋₀}ƒ(x). It is shown below that σₐₜ₋₀σₐₜ₋₁ is reducible and thus does not form part of I.

ƒ(σₐₜ₋₁σₐₜ₋₀σₐₜ₋₁x)=ƒ(σₐₜ₋₀σₐₜ₋₁σₐₜ₋₀x)=t_{σ}_{ₐₜ₋₀}ƒ(σₐₜ₋₁σₐₜ₋₀x)=t_{σ}_{ₐₜ₋₀}t_{σ}_{ₐₜ₋₁}ƒ(σₐₜ₋₀x)=t_{σ}_{ₐₜ₋₀}t_{σ}_{ₐₜ₋₁}t_{σ}_{ₐₜ₋₀}ƒ(x)=t_{σ}_{ₐₜ₋₁}t_{σ}_{ₐₜ₋₀}t_{σ}_{ₐₜ₋₁}ƒ(x)=t_{σ}_{ₐₜ₋₁}t_{σ}_{ₐₜ₋₀}ƒ(σₐₜ₋₁x)=t_{σ}_{ₐₜ₋₁}ƒ(σₐₜ₋₀σₐₜ₋₁x)

Note that as the group identity σₐₜ₋₁σₐₜ₋₀σₐₜ₋₁=σₐₜ₋₀σₐₜ₋₁σₐₜ₋₀ holds, it follows that t_{σ}_{ₐₜ₋₀}t_{σ}_{ₐₜ₋₁}t_{σ}_{ₐₜ₋₀}=t_{σ}_{ₐₜ₋₁}t_{σ}_{ₐₜ₋₀}t_{σ}_{ₐₜ₋₁} since t_{σ} acts as a homomorphism.

### Verifying the Correctness of a Hardware Design that Implements a Permutation Respecting Function

As described above, the correctness of a hardware design that implements a permutation respecting function can be verified by (i) verifying that the hardware design produces a correct output in response to each input vector in a subset of input vectors B; and (ii) verifying that the hardware design is permutation respecting for each input vector permutation in a set of input vector permutations for all input vectors x in the input space X by verifying, for each permutation in a generating set of input vector permutations for the set of input vector permutations, that the hardware design is permutation respecting over the input space X. The subset of valid input vectors and the one or more input vector permutations are selected so that each input vector x in the input space X that is not in the subset of input vectors can be obtained by applying one or more of the input vector permutations in the set to an input vector in the subset.

### Generating Set

As described above a generating set G of input vector permutations for the relevant input vector permutations R (i.e. the input vector permutations to be verified) is a set of input vector permutations ϕᵢ (e.g. G={ϕᵢ|i=1, . . . , m}) from which all of the relevant input vector permutations R can be generated. Accordingly, G⊆R⊆E⊆Sym(n) and it follows that R is a group if it is generated as follows: A relevant input vector permutation σ can be generated from a generating set G of input vector permutations if the input vector permutation σ can be written as a sequence of the input vector permutations ϕᵢ in the generating set G. Specifically, a relevant input vector permutation σ can be generated from a generating set G of input vector permutations if the input vector permutation σ can be written in the form:

σ=ϕᵢ_{₀}^{s}^{₀} . . . ϕᵢ_{ₖ}^{s}^{ₖ} for some i₀ . . . iₖ∈{1, . . . m}, s₀ . . . sₖ∈{1, −1}

where ϕᵢ¹ is equal to ϕᵢ, and ϕᵢ⁻¹ is the reverse or inverse permutation of ϕᵢ such that ϕᵢ¹ϕᵢ⁻¹ or ϕᵢ⁻¹ϕᵢ¹ leaves all the elements in the same order.

Verifying that for every input vector permutation in the generating set G of input vector permutations that the outputs of an instantiation of the hardware design in response to: (i) any input vector x in the input space X; and (ii) the permutation of the input vector x, are permutation related, verifies that the instantiation of the hardware design will produce permutation related outputs for any input vector x and any relevant permutation of the input vector σx.

In some cases, the generating set G may comprise only adjacent transpositions. A transposition is a permutation in which the position of two elements xᵢ in the n-element input vector is swapped (e.g. element i is swapped with element i+4) and all other elements remain in the same position. An adjacent transposition is a transposition in which the position of two adjacent elements is swapped (e.g. element i is swapped with element i+1). An adjacent transposition which swaps the i^{th} element and the (i+1)^{th} element is denoted σₐₜ₋ᵢ (see, for example, FIG. 2):

σₐₜ₋ᵢx=σₐₜ₋ᵢ(x₀, . . . , xᵢ₋₁, xᵢ, xᵢ₊₁, xᵢ₊₂, . . . , xₙ₋₁)=(x₀, . . . , xᵢ₋₁, xᵢ₊₁, xᵢ, xᵢ₊₂, . . . , xₙ₋₁)

For example, the permutation σₐₜ₋₀ swaps the 0^{th} element and the 1^{st} element:

σₐₜ₋₀x=(x₁, x₀, x₂, . . . , xₙ₋₁)

Since an adjacent transposition is the smallest change to an input vector, formal verification tools are typically (although not always) able to efficiently prove that the outputs for any input vector x and for the permutation of that input vector according to an adjacent transposition σₐₜ₋ᵢ are permutation related.

It can easily be shown that any input vector permutation σᵢ in Sym(n) can be generated from the set of adjacent transpositions {σₐₜ₋₀, σₐₜ₋₁, . . . , σₐₜ₋ₙ₋₂}. For example, as described above, if the input vectors x comprise three input elements (i.e. n=3) then there are n!=6 permutations i.e. Sym(n)={σ₀, σ₁, σ₂, σ₃, σ₄, σ₅}. Each of the input vector permutations σᵢ can be written as a combination of one or more adjacent transpositions in the set {σₐₜ₋₀, σₐₜ₋₁} as shown below:

σ₀(x₀, x₁, x₂)=(x₀, x₁, x₂)=σₐₜ₋ᵢσₐₜ₋ᵢx=x

σ₁(x₀, x₁, x₂)=(x₀, x₂, x₁)=σₐₜ₋₁x

σ₂(x₀, x₁, x₂)=(x₁, x₀, x₂)=σₐₜ₋₀x

σ₃(x₀, x₁, x₂)=(x₁, x₂, x₀)=σₐₜ₋₁σₐₜ₋₀x

σ₄(x₀, x₁, x₂)=(x₂, x₀, x₁)=σₐₜ₋₀σₐₜ₋₁x

σ₅(x₀, x₁, x₂)=(x₂, x₁, x₀)=σₐₜ₋₁σₐₜ₋₀σₐₜ₋₁x

Specifically, the first permutation σ₀ can be generated by performing any of the adjacent transpositions twice (i.e. by swapping any two elements and then swapping them again); the second permutation σ₁ can be generated by swapping the 1^{st} and 2^{nd} elements (i.e. by performing permutation σₐₜ₋₁); the third permutation σ₂ can be generated by swapping the 0^{th} and 1^{st} elements (i.e. by performing permutation σₐₜ₋₀); the fourth permutation σ₃ can be generated by swapping the 0^{th} and 1^{st} elements (i.e. by performing permutation σₐₜ₋₀) and then swapping the 1^{st} and 2^{nd} elements (i.e. by performing permutation σₐₜ₋₁); the fifth permutation σ₄ can be generated by swapping the 1^{st} and 2^{nd} elements (i.e. by performing permutation σₐₜ₋₁) and then swapping the 0^{th} and 1^{st} elements (i.e. by performing permutation σₐₜ₋₀); and the sixth permutation σ₅ can be generated by swapping the 1^{st} and 2^{nd} elements (i.e. by performing permutation σₐₜ₋₁), swapping the 0^{th} and 1^{st} elements (i.e. by performing permutation σₐₜ₋₀), and then swapping the 1^{st} and 2^{nd} elements (i.e. by performing permutation σₐₜ₋₁).

Accordingly, in some cases, the generating set G may comprise {σₐₜ₋₀, σₐₜ₋₁, . . . , σₐₜ₋ₙ₋₂}. Verifying that an instantiation of the hardware design is permutation respecting for each of the permutations in such a generating set comprises generating and verifying a set of assertions for each of n−1 permutations. This significantly reduces, particularly for large n, the number of assertions that have to be generated relative to verifying each relevant input vector permutation as there may be up to n! relevant input vector permutations.

Using such a generating set also allows the input vectors over which the permutation is verified to be reduced to a subset of the input vectors x in the input space X instead of all of the input vectors x in the input space X. Since adjacent transpositions are self-inverse (i.e. σₐₜ₋ᵢ=σₐₜ₋ᵢ⁻¹), verifying that an instantiation of the hardware design is permutation respecting for each adjacent transposition σₐₜ₋ᵢ over the subset of input vectors where xᵢ and xᵢ₊₁ are in ascending order(i.e. xᵢ≤xᵢ₊₁) verifies that the instantiation of the hardware design is permutation respecting for the adjacent transposition over all x in the input space X. This is because if it is proven that A(x)=A(σₐₜ₋ᵢx) for all x where xᵢ≤xᵢ₊₁ then for any input vector x in the input set, either xᵢ<xᵢ₊₁ meaning it will occur on the left-hand side of the equation, xᵢ>xᵢ₊₁ meaning it will occur on the right-hand side of the equation, or xᵢ=xᵢ₊₁ meaning it will occur on both the left-hand side and the right-hand side of the equation. Reducing the input space in this manner reduces the number of input vectors over which the permutation is verified by a factor of two. Although this may seem like a trivial reduction it can significantly reduce the amount of time to formally verify that an instantiation of a hardware design is permutation respecting for an adjacent transposition. Similarly to the above, the verification that A(x)=A(σₐₜ₋ᵢx) could be reduced to the subset of input vectors where xᵢ and xᵢ₊₁ are in descending order.

In other cases, the generating set G may comprise one or more adjacent transpositions and a cycle permutation. A cycle permutation, denoted σ_{c}, is the permutation in which every element is moved to the next position and the element in the last position is moved to the first (or 0^{th}) position. In other words, the 0^{th} element moves to the 1^{st} position, the 1^{st} element moves to the 2^{nd} position, and so on, so that the i^{th} element is moved to the (i+1)^{th} position, up to the (n−2)^{th} element which is moved to the (n−1)^{th} position. The (n−1)^{th} element is then moved to the 0^{th} position (see for example, FIG. 2):

σ_{c}x=(xₙ₋₁, x₀, x₁, . . . , xₙ₋₂)

It can easily be shown that any input vector permutation σᵢ in Sym(n) can be generated from the set of permutations {σₐₜ₋₀, σ_{c}}. For example, as described above, if the input vectors x comprise three input elements (i.e. n=3) then there are n!=6 permutations i.e. Sym(n)={σ₀, σ₁, σ₂, σ₃, σ₄, σ₅}. Each of the input vector permutations σᵢ can be written as a combination of one or more permutations in the set {σₐₜ₋₀, σ_{c}} as shown below:

σ₀(x₀, x₁, x₂)=(x₀, x₁, x₂)=σₐₜ₋₀σₐₜ₋₀x=x

σ₁(x₀, x₁, x₂)=(x₀, x₂, x₁)=σₐₜ₋₀σ_{c}x

σ₂(x₀, x₁, x₂)=(x₁, x₀, x₂)=σₐₜ₋₀x

σ₃(x₀, x₁, x₂)=(x₁, x₂, x₀)=σ_{c}σ_{c}x

σ₄(x₀, x₁, x₂)=(x₂, x₀, x₁)=σ_{c}x

σ₅(x₀, x₁, x₂)=(x₂, x₁, x₀)=σ_{c}σₐₜ₋₀x

Specifically, if the first permutation is the identity map and can be generated by performing σₐₜ₋₀ twice; the second permutation σ₁ can be generated by cycling the elements (i.e. by performing permutation σ_{c}) and then swapping the 0^{st} and 1^{nd} elements (i.e. by performing permutation σₐₜ₋₀); the third permutation σ₂ can be generated by swapping the 0^{th} and 1^{st} elements (i.e. by performing permutation σₐₜ₋₀); the fourth permutation σ₃ can be generated by cycling the elements (i.e. by performing permutation σ_{c}) and then by cycling the elements again (i.e. by performing permutation σ_{c}); the fifth permutation σ₄ can be generated by cycling the elements (i.e. by performing permutation σ_{c}); and the sixth permutation σ₅ can be generated by swapping the 0^{th} and 1^{st} elements (i.e. by performing permutation σₐₜ₋₀), and then cycling the elements (i.e. by performing permutation σ_{c}).

Accordingly, in some cases, the generating set G may comprise {σₐₜ₋₀, σ_{c}} (see, for example FIG. 2). Verifying that an instantiation of the hardware design is permutation respecting for each input vector permutation in such a generating set G comprises generating and verifying a set of assertions for only two permutations. This significantly reduces, particularly for large n, the number of assertions that have to be generated relative to verifying each relevant input vector permutation as there may be up to n! relevant input vector permutations, and relative to verifying each input vector permutation in a generating set comprising n−1 adjacent transpositions. However, since formal verification tools tend to be better at verifying things that are similar than things that are different—and x will be significantly different from σ_{c}x as all the elements will be in different positions—some formal verification tools may not be able to efficiently verify that an instantiation of the hardware design is permutation respecting for a cycle permutation. This may, however, be dependent on the formal verification tool and/or the configuration (e.g. internal structure) of the component.

It will be evident to a person of skill in the art that these are example generating sets only and that other suitable generating sets may be used. For example, other generating sets include any adjacent transposition (e.g. σₐₜ₋₁) and a cycle permutation.

### Method of Verifying Correctness

The methods described above with respect to FIGS. 3 to 5 for verifying that a hardware design is permutation respecting for a plurality of input vector permutations can be used to verify part (ii) of the method described above for verifying the correctness of a hardware design that implements a permutation respecting function. Specifically, the methods described above with respect to FIGS. 3 to 5 can be used to verify that a hardware design is permutation respecting for each of the input vector permutations in a generating set G of input vector permutations, over all input vectors x in the input space X by dividing the input vector permutations in the generating set G into a first subset of input vector permutations and a second subset of input vector permutations. The input vector permutations in the first subset are verified in accordance with block 304 of the method 300 of FIG. 3 (i.e. the input vectors for which the input vector permutations in the first subset are verified are not reduced based on the verification of one or more other input vector permutations) and the input vector permutations in the second subset are verified in accordance with block 306 of the method 300 of FIG. 3 (i.e. the input vectors for which the input vector permutations in the second subset are verified are reduced based on the successful verification of one or more other input vector permutations (the one or more other input vector permutations may be in the first subset or the second subset)).

The division of the input vector permutations in the generating set G into the first and second subsets may depend on the input vector permutations in the generating set, the component and the hardware design. In general, it may be advantageous to place the input vector permutations for which verifying the hardware design is permutation respecting is more difficult in the second subset, and place the input vector permutations for which verifying the hardware design is permutation respecting is easier in the first subset. Testing has shown that, in some cases, where a generating set G comprises a set of adjacent transpositions (e.g. G={σₐₜ₋₀, σₐₜ₋₁, . . . , σₐₜ₋ₙ₋₂}) it is the centre adjacent transposition (i.e. the adjacent transposition in which the two middle input elements are transposed) that is the most difficult to verify. In these cases, all of the adjacent transpositions, except the centre adjacent transposition, may be placed in the first subset and the centre transposition may be placed in the second subset. Testing has also shown that, in some cases, where a generating set comprises one or more adjacent transpositions and a cycle transposition (e.g. G={σₐₜ₋₀, σ_{c}}) it is the cycle transposition that is the most difficult to verify. In these cases, the one or more adjacent transpositions may be placed in the first subset and the cycle transposition may be placed in the second subset. It will be evident to a person of skill in the art that these are examples only and the input vector permutations in a generating set of input vector permutations may be divided into first and second subsets of input vector permutations in any suitable manner.

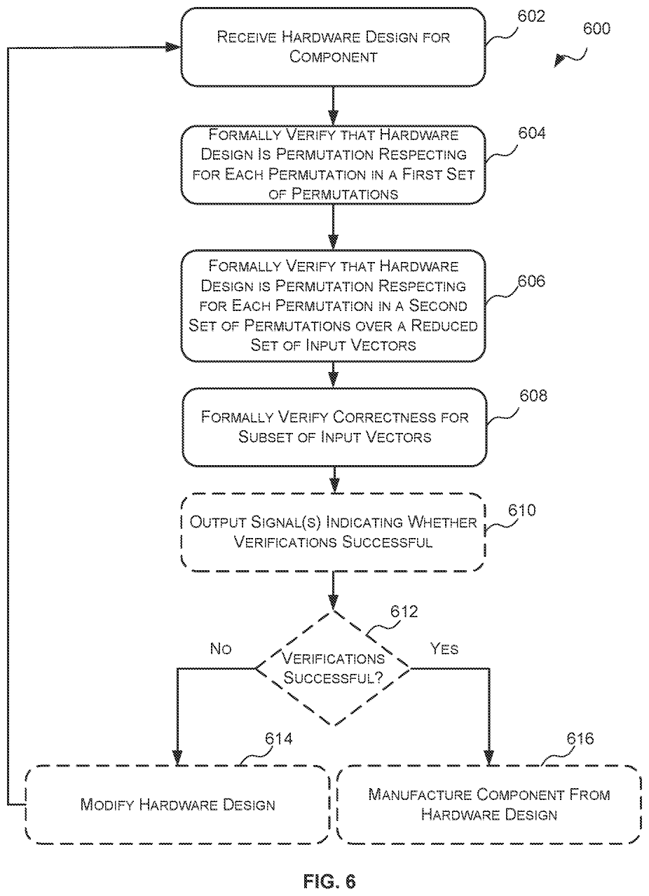

Reference is now made to FIG. 6 which illustrates an example method 600 of verifying the correctness of a hardware design that implements a permutation respecting function using the method of FIG. 3. The method 300 may be implemented by a computing-based device such as, but not limited to, the computing-based device 800 described below with respect to FIG. 8. For example, there may be a computer readable storage medium having stored thereon computer readable instructions that, when executed at a computing-based device, cause the computing-based device to perform the method 600 of FIG. 6.

The method begins at block 602 where a hardware design for a permutation respecting function is received. The function may be permutation respecting for all input vector permutations or only a subset of the input vector permutations. As described above the input vector permutations for which the function is permutation respecting are referred to as the respected input vector permutations E, wherein E⊆Sym(n). Block 602 generally corresponds to block 302 of the method 300 of FIG. 3 therefore any comments above in relation to block 302 equally apply to block 602. Once the hardware design has been received the method 600 proceeds to block 604.

At block 604, it is verified that the hardware design is permutation respecting for each input vector permutation in a first subset of input vector permutations for all input vectors x in the input space X by, for each input vector permutation in the first subset of input vector permutations, formally verifying for each input vector x in a set of input vectors K that the output of an instantiation of the hardware design in response to that input vector and the output of the instantiation of the hardware design in response to the input vector permutation of that input vector are permutation related. As described above, the input vector permutations in the first subset of input vector permutations are input vector permutations in a generating set of input vector permutations for a set of relevant input vector permutations, the relevant input vector permutations being all or a subset of the respected input vector permutations.

The set of input vectors K used to verify that a hardware design is permutation respecting for a particular input vector permutation may include all the input vectors in the input space X or only a subset of the input vectors in the input space. For example, as described above, it can be verified that a hardware design is permutation respecting for an adjacent transposition which swaps the i^{th} and (i+1)^{th} input elements for all input vectors in the input space X, by explicitly verifying that an instantiation of the hardware design generates permutation related outputs for input vectors wherein xᵢ and xᵢ₊₁ are in ascending order or for input vectors wherein xᵢ and xᵢ₊₁ are in descending order. In contrast to block 606, the selection of the set of input vectors K is not selected based on the verification of one or more other input vector permutations.

Formally verifying that an instantiation of the hardware design will produce permutation related outputs in response to any input vector in a set of input vectors and the permutation of that input vector may comprise generating a test bench in a formal verification language comprising one or more assertions to be verified and optionally one or more constraints (e.g. assumptions) and/or modelling logic; linking the test bench to the hardware design; and formally verifying, using a formal verification tool, that the one or more assertions are true (or hold) for the hardware design, and outputting one or more signals indicating whether the one or more assertions were successfully verified. An example test bench is described below with respect to FIG. 7.

The formal verification that an instantiation of the hardware design is permutation respecting for a particular input vector permutation in the first subset may be performed separately or jointly from the formal verification that an instantiation of the hardware design is permutation respecting for another input vector permutation in the first subset.

Once the verification, for each of the input vector permutations in the first subset of input vector permutations, that the hardware design is permutation respecting with respect to that input vector permutation has been performed, the method 600 proceeds to block 606.

At block 606, it is formally verified that the hardware design is permutation respecting for each input vector permutation in a reduced input vector subset S, for each input vector permutation in the second subset of input vector permutations, by formally verifying for each input vector x in the reduced input vector subset S that the output of an instantiation of the hardware design in response to that input vector and the output of the instantiation of the hardware design in response to the input vector permutation of that input vector are permutation related. As described above, the input vector permutations in the second subset of input vector permutations are input vector permutations in a generating set of input vector permutations for a set of relevant input vector permutations, the relevant input vector permutations being all or a subset of the respected input vector permutations.

The reduced input vectors subset S for an input vector permutation in the second subset is selected based on the knowledge that it has been verified that the hardware design is permutation respecting for one or more other input vector permutations. As described above the one or more other input vector permutations may be an input vector permutation in the first subset or the second subset. The reduced input vector subset S for an input vector permutation in the second subset may be generated in accordance with any of the methods described above.

Formally verifying that an instantiation of the hardware design will produce permutation related outputs in response to any input vector in a reduced input vector subset S and the permutation of that input vector may comprise generating a test bench in a formal verification language comprising one or more assertions to be verified and optionally one or more constraints (e.g. assumptions) and/or modelling logic; linking the test bench to the hardware design; and formally verifying, using a formal verification tool, that the one or more assertions are true (or hold) for the hardware design, and outputting one or more signals indicating whether the one or more assertions were successfully verified. An example test bench is described below with respect to FIG. 7.

Once the verification, for each of the input vector permutations in the second subset of input vector permutations, that the hardware design is permutation respecting with respect to that input vector permutation has been performed, the method 600 proceeds to block 608.

At block 608, it is formally verified that an instantiation of the hardware design (i.e. an instantiation of the component described by the hardware design) produces the correct output for a subset of the valid input vectors. Specifically, if the input space representing the valid input vectors x is X such that all input vectors x are elements of X (x∈X) then it is formally verified that an instantiation of the hardware design produces the correct result for all x in [symbol] (x∈ [symbol] ) where [symbol] is a subset of X ( [symbol] ⊂X). The term subset is used herein to mean a set that is less than the set from which it was formed. Accordingly, the subset [symbol] comprises fewer input vectors than the input space X. The input vectors that form the subset [symbol] may be referred to as the base cases or the base input vectors, and formally verifying that an instantiation of the hardware design produces the correct output for the input vectors in the subset [symbol] may be referred to as formally verifying the base cases.

The subset [symbol] is selected so that all input vectors x in the input space X that are not in the subset [symbol] can be obtained by applying one or more of the input vector permutations verified in blocks 604 and 606 to an input vector x in the subset [symbol] . Accordingly, the subset [symbol] includes at least one input vector for each possible set of input elements that represents one permutation, or one ordering, of that set of input elements.

Where the input vector permutations that are verified in blocks 604 and 606 comprise all permutations, the subset [symbol] may include only one input vector for each possible set of input elements xᵢ (which may be referred to herein as a minimum-sized subset [symbol] ). Selecting a subset [symbol] that only comprises one input vector for each possible set of input elements xᵢ reduces the number of states that have to be verified which may allow the formal verification of the correctness of the output for the input vectors in the subset [symbol] to complete more quickly. In these cases, the subset [symbol] may be selected so as to include all input vectors x in the input set X where the input elements xᵢ are in a predetermined order.

Preferably the subset [symbol] comprises input vectors where the output thereof is easy to deduce. The subset [symbol] may be selected based on the permutation respecting function that is implemented by the component. Testing has shown that a good subset [symbol] for a sorting function is the subset [symbol] of input vectors where the output is equal to the input. Accordingly, the subset [symbol] for a sorting function which sorts the input elements into ascending order may comprise the input vectors in which the input elements x i are in ascending order (i.e. x₀≤x₁≤ . . . ≤xₙ₋₁). Similarly, the subset [symbol] for a sorting function which sorts the input elements in descending order may comprises the input vectors in which the input elements are in descending order (i.e. x₀≥x₁≥ . . . ≥xₙ₋₁).

A subset [symbol] that includes the input vectors in which the input elements are in ascending or descending order may also be appropriate for minimum and maximum functions which output the minimum or maximum of the input elements, and for a median function that returns the median input element in the input vector because the correct output for such base cases can be determined directly from the input vector. For example, the output of a minimum or maximum function will be the first or last input element of an input vector in which the input elements are in ascending ordering. A suitable subset [symbol] for a search function which indicates whether a particular element is in the input vector may be the input vectors in which the particular element is the first element in the input vector or the particular element is not in the input vector at all. A suitable subset [symbol] for a counting function which counts the number of times an element occurs in an input vector may be the input vectors in which the element occurs a predetermined number of times at the beginning of the input vector and nowhere else. It will be evident to a person of skill in the art that these are example subsets [symbol] only and that other subsets [symbol] may be used.

Where the function implemented by the component is not permutation respecting for all possible input vector permutations (i.e. the function is not permutation respecting for all σ∈Sym(n)) the subset may be expanded to cover the permutations for which the function is not permutation respecting.

In general, any permutation that is not verified in blocks 604 and 606 (i.e. any permutation that is not in the respecting input vector permutations) is verified by verifying the input vectors in the subset [symbol] . For example, if the permutation respecting function implemented by the component is not permutation respecting for a permutation in which the first two input elements (e.g. x₀ and x₁) are swapped then the subset may include input vectors (x₀, x₁, . . . , xₙ₋₁) and (x₁, x₀, . . . , xₙ₋₁) for all sets of input elements.

Formally verifying that an instantiation of the hardware design produces the correct output in response to each input vector in a subset [symbol] may comprise generating a test bench in a formal verification language comprising one or more assertions to be verified and optionally one or more constraints (e.g. assumptions) and/or modelling logic; linking the test bench to the hardware design; and formally verifying, using a formal verification tool, that the one or more assertions are true (or hold) for the hardware design, and outputting one or more signals indicating whether the one or more assertions were successfully verified. An example test bench is described below with respect to FIG. 7.

In some cases, the one or more formal assertions used to verify an instantiation of the hardware design produces the correct output for the base cases may comprise one or more formal assertions that assert a property that establishes the correctness of the output solely from the input. Such assertions may be suitable in cases where, for example, the output for the base cases is equal to all or part of the input vector. For example, where the hardware design is for a component that implements a sorting function that outputs a vector comprising the input elements in ascending order, and the base cases include the input vectors in which the input elements are in ascending order, the one or more formal assertions may comprise an assertion that asserts that the output vector of an instantiation of the hardware design is equal to the input vector of the instantiation of the hardware design.

In other cases, the one or more formal assertions used to verify an instantiation of the hardware design produces the correct output for the base cases may comprise one or more formal assertions that assert a property that establishes the correctness of the output by comparing the output to a model of the component. Such assertions may be suitable in cases where, for example, the output for the base cases is more complex to calculate and/or is not common across all base cases. For example, where the hardware design is for a component that implements a multiplication function that outputs the product of the input elements, and the base cases include input vectors in which the input elements are in ascending order, the one or more formal assertions may comprise an assertion that compares the output of the instantiation of the hardware design to the output of a model of the component.

Once it has been formally verified that an instantiation of the hardware design produces the correct output in response to each input vector x in the subset [symbol] the method 600 may proceed to blocks 610, 612, 614 and/or 616 which correspond to blocks 308, 310, 312 and 314 respectively of the method 300 of FIG. 3.

### System

Reference is now made to FIG. 7 which illustrates an example system 700 for performing the method 300 of FIG. 3 or the method 600 of FIG. 6. The system 700 may be implemented by one or more computing-based devices, such as the computing-based device 800 described below with reference to FIG. 8. For example, one or more of the components of the system 700 of FIG. 7 may be implemented as computer-readable instructions that, when executed at a computing-based-device, cause the computing-based device to perform the function of that component described below.

The system 700 comprises a hardware design for a component that implements a permutation respecting function 702; a formal verification tool 704; a test bench 706 for each input vector permutation in a first subset of input vector permutations; and a test bench 708 for each input vector permutation in a second subset of input vector permutations. Where the system is used to implement the method 600 of FIG. 6 the system 700 may also comprise a test bench 710 to verify the base cases. Each test bench comprises one or more assertions and one or more assumptions.

Depending on the format of the assertions in the test benches the system 700 may also comprise a second instance of the hardware design 712 and/or a model of the hardware design 714. Specifically, if one or more of the assertions compares the output of an instantiation of the hardware design to another instantiation of the hardware design then the system 700 may comprise a second instance of the hardware design 712, and if one or more of the assertions compares the output of an instantiation of the hardware design to the output of a model of the hardware design then the system 700 may comprise a model of the hardware design 714. In general, the formal verification tool 704 is configured to formally verify the assertions are true for the hardware design under the associated conditions/assumptions using mathematical reasoning.

As described above, a hardware design is a description of the structure and function of an integrated circuit which, when processed at an integrated circuit manufacturing system, causes the integrated circuit manufacturing system to generate an integrated circuit described by the hardware design. Accordingly, a hardware design 702, 712 for a component that implements a permutation respecting function is a description of the structure and function of an integrated circuit that implements a permutation respecting function, which, when processed at an integrated circuit manufacturing system causes the integrated circuit manufacturing system to generate an integrated circuit that implements a permutation respecting function.

As described above, the formal verification tool 704 is a software tool that is capable of performing formal verification of an integrated circuit hardware design. Formal verification tools include, but are not limited to, formal model checkers (which also may be referred to as formal property checkers) which are configured to formally verify a property of a hardware design, and formal equivalence checkers which are configured to formally verify the equivalence of two designs (e.g. two hardware designs, a hardware design and a netlist, or a hardware design and a model of the hardware design etc).

Although FIG. 7 illustrates a single formal verification tool 704, in other examples the system may comprise multiple formal verification tools which allow the formal verification of the assertions in the various test benches 706, 708, 710 to be performed in parallel. Where there are multiple formal verification tools all of the formal verification tools may be of the same type (e.g. all of the formal verification tools may be formal model checkers or all of the formal verification tools may be formal equivalence checkers), or, two or more of the formal verification tools may be of different types (e.g. at least one of the formal verification tools may be a formal model checker and at least one of the formal verification tools may be a formal equivalence checker). The formal verification tools may be of different types in some cases because it may be more efficient in these cases to verify some of the assertions using a formal model checker and verify other assertions using a formal equivalence checker. For example, as described in more detail below, it may be more efficient, in some cases, to verify the base case assertions using a formal model checker and to verify the permutation assertions using a formal equivalence checker.

There will be a test bench 706, 708, 710 for each input vector permutation that is verified in block 304 or 306. Each test bench comprises one or more assertions and one or more conditions under which the assertions are to be verified, such that if the one or more assertions are verified to be true for the hardware design under the specified conditions then it will be verified that an instantiation of the hardware design is permutation respecting for the input vector permutation (i.e. the hardware design produces permutation related outputs for an input vector and the permutation of that input vector) over a specified set of input vectors. For a test bench for an input vector permutation verified in block 306, the specified set of input vectors comprises the reduced input vector subset S (or S₁, S₂, S₃ₐ, S_{3b}).

The assertions for a test bench 706, 708 for an input vector permutation may comprise an assertion that asserts a property that establishes that the instantiation of the hardware design respects that specific permutation by comparing the output of a first instantiation of the hardware design to the output of a second instantiation of the hardware design. The following is an example of such an assertion where A1 is the component of the first instantiation of the hardware design and A2 is the component of the second instantiation of the hardware design and yi are the output elements:
assert property ((A1.y0==A2.y0) && (A1.y1==A2.y1) && (A1.y2==A2.y2))
   In these cases, the formal verification comprises performing a comparison of two instances of the hardware design for the component. Since formal equivalence checkers are designed and optimized for comparing two designs it may be beneficial in these cases to verify such permutation assertions using a formal equivalence checker. However, while using a formal equivalence checker in these cases may provide certain advantages (e.g. in terms of efficiency), a person of skill in the art would understand that this does not, however, preclude the use of a formal model checker to verify such permutation assertions.

The test bench for the bench cases 710 comprises one or more assertions and one or more conditions under which the assertions are to be verified, such that if the one or more assertions are verified to be true for the hardware design under the specified conditions, then it will be verified that an instantiation of the hardware design 702 produces the correct (or expected) result for a subset of input vectors of the input space. The conditions or assumptions may be used to specify the subset of input vectors which are to be verified.

In some cases, the assertions in the test bench for the base cases 710, may comprise an assertion that asserts a property that establishes that the output is correct based only on the signals and/or states of a single instance of the hardware design. For example, where the component implements a function that sorts the input elements in ascending order the assertions may comprise an assertion that states that the output is equal to the input. The following is an example of such an assertion where there are three input elements xi and three output elements yi:
assert property ((x0==y0) && (x1==y1) && (x2==y2))
   In these cases, the formal verification comprises evaluating states of a single instance of the hardware design. Since formal model checkers are optimized to verify properties of a single design over several clock cycles it may be beneficial in these cases to verify such base case assertions using a formal model checker. However, while using a formal model checker in these cases may provide certain advantages (e.g. in terms of efficiency), a person of skill in the art would understand that this does not, however, preclude the use of a formal equivalence checker to verify such base case assertions.

In other cases, the assertion in the test bench for the base cases 710 may comprise an assertion that asserts a property that establishes that the output is correct (or is the expected output) by comparing the output of an instantiation of the hardware design to the output of a model of the hardware design. The following is an example of such an assertion wherein A is the component of the hardware design and M is the model of the component and yi are the output elements:
assert property ((A.y0==M.y0) && (A.y1==M.y1) && (A.y2==M.y2)))
   In these cases, the formal verification comprises performing a comparison of an instantiation of the hardware design for the component and a model of the component. Since formal equivalence checkers are designed and optimized for comparing two designs it may be beneficial in these cases to verify such base case assertions using a formal equivalence checker. However, while using a formal equivalence checker in these cases may provide certain advantages (e.g. in terms of efficiency), a person of skill in the art would understand that this does not, however, preclude the use of a formal model checker to verify such base case assertions. A model of the component is generally a high-level model (e.g. written in C) which simulates the behaviour of the component.

Each test bench 706, 708, 710 is bound to the appropriate hardware design(s) 702, 712 and/or model 714 to be able to verify the asserted properties. The hardware design(s), model (if required), test benches 706, 708, 710, and bindings are then loaded into the formal verification tool (or formal verification tool). The formal verification tool is then configured to verify each set of assertions for the hardware design under the associated conditions. In other words, the formal verification tool is configured to formally verify the assertions in each test bench are true under the conditions/assumptions set out in the test bench. Where there is a plurality of formal verification tools, the assertions in two or more of the test benches 706, 708, 710 may be performed in parallel to reduce the time to complete the verification.

As described above, in formal verification the hardware design is transformed into a mathematical model (e.g. a state transition system, or a flow graph) to thereby provide an instantiation of the hardware design which can be tested to verify the hardware design, and the formal properties to be verified (e.g. the asserted properties) are expressed using mathematical logic using a precise syntax or language with a precise mathematical syntax and semantics.

A formal assertion is verified by searching the entire reachable state space of the instantiation of the hardware design (e.g. state-transition system, or flow graph) without explicitly traversing all the states. The search is done by, for example, encoding the states using efficient Boolean encodings using Binary decision diagrams (BDDS), or using advanced SAT (satisfiability-based bounded model checking) based techniques. In some cases, tools can be used to implement techniques, such as, but not limited to, abstraction, symmetry, symbolic indexing, and invariants to improve performance and achieve scalability.

When a formal verification tool 704 is used to verify an assertion, the formal verification tool 704 may output an indication of whether or not the assertion is valid (i.e. the asserted property is true for all valid states or sequence of states), which may also be referred to herein as the assertion being successfully verified. The output may be yes, the assertion is valid or has been successfully verified; no, the assertion is not valid (i.e. it is not true or has failed for at least one valid state or sequence of states) or has not been successfully verified; or the formal verification was inconclusive. The formal verification may be inconclusive, for example, because the computing-based device running the formal verification tool 704 has run out of memory or because the formal verification tool 704 has determined that a certain amount of progress has not been made after a predefined period of time.

Where an assertion is not valid or has not been successfully verified, the formal verification tool 704 may also output information indicating a state or sequence of states of the hardware design which causes the assertion to fail (i.e. a counter example). For example, the formal verification tool 704 may output a trace of the verification indicating at what point, state or sequence of states the failure occurred.

Where one of the verifications is performed via other verification methods the system may additionally, or alternatively, comprise one or more other verification tools. For example, where one or more of the verifications is performed via simulation-based verification the system may comprise a simulation engine.

As is known to those of skill in the art, a simulation engine is a software tool capable of performing simulation-based verification of a hardware design. In particular, a simulation engine monitors the output of one or more instantiations of the hardware design in response to each input vector in the test set (e.g. each input vector in the subset [symbol] to determine a specific property (e.g. that output of an instantiation is correct with respect to the function, or that the outputs of two different instantiations of the hardware design produce permutation related outputs for related input vectors).

A simulation engine may perform the simulation-based verification using any known method. For example, the simulation engine may receive the hardware design in, for example HDL, convert the HDL to another language, such as C, and perform the simulation on the C code; the simulation engine may receive the hardware design as, for example, HDL and perform the simulation directly on the HDL; or the simulation engine may implement the hardware design in hardware and perform the simulation on the hardware. Once the simulation is complete the simulation engine may output an indication of whether or not the hardware design passed the simulation.

FIG. 8 illustrates various components of an exemplary computing-based device 800 which may be implemented as any form of a computing and/or electronic device, and in which embodiments of the methods and systems described herein may be implemented.

Computing-based device 800 comprises one or more processors 802 which may be microprocessors, controllers or any other suitable type of processors for processing computer executable instructions to control the operation of the device in order to verify a property of a hardware design for a component that implements a permutation respecting function. In some examples, for example where a system on a chip architecture is used, the processors 802 may include one or more fixed function blocks (also referred to as accelerators) which implement a part of the method of verifying that a hardware design for a component that implements a permutation respecting function is permutation respecting for a plurality of input vector permutations, or the method of verifying the correctness a hardware design for a component that implements a permutation respecting function, in hardware (rather than software or firmware). Platform software comprising an operating system 804 or any other suitable platform software may be provided at the computing-based device to enable application software, such as a formal verification tool 704, to be executed on the device.

The computer executable instructions may be provided using any computer-readable media that is accessible by computing-based device 800. Computer-readable media may include, for example, computer storage media such as memory 806 and communications media. Computer storage media (i.e. non-transitory machine readable media), such as memory 806, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Although the computer storage media (i.e. non-transitory machine readable media, e.g. memory 806) is shown within the computing-based device 800 it will be appreciated that the storage may be distributed or located remotely and accessed via a network or other communication link (e.g. using communication interface 808).

The computing-based device 800 also comprises an input/output controller 810 arranged to output display information to a display device 812 which may be separate from or integral to the computing-based device 800. The display information may provide a graphical user interface. The input/output controller 810 is also arranged to receive and process input from one or more devices, such as a user input device 814 (e.g. a mouse or a keyboard). This user input may be used to initiate verification. In an embodiment the display device 812 may also act as the user input device 814 if it is a touch sensitive display device. The input/output controller 810 may also output data to devices other than the display device, e.g. a locally connected printing device (not shown in FIG. 8).

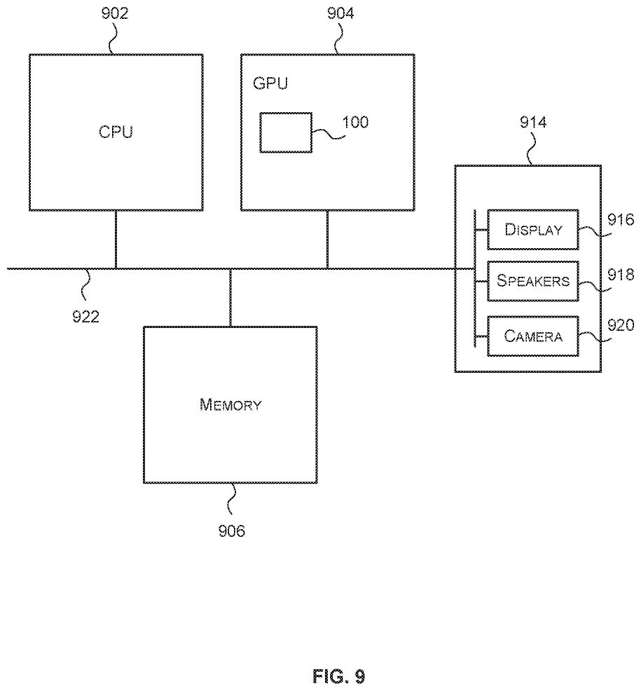

FIG. 9 shows a computer system in which a component 100 that implements a permutation respecting function may be implemented. The computer system comprises a CPU 902, a GPU 904, a memory 906 and other devices 914, such as a display 916, speakers 918 and a camera 920. The GPU 904 is shown as comprising the component 100. In other examples, the component 100 may be implemented in the CPU 902. The components of the computer system can communicate with each other via a communications bus 922.

A component that implements a permutation respecting function described herein may be embodied in hardware on an integrated circuit. Generally, any of the functions, methods, techniques or components described above can be implemented in software, firmware, hardware (e.g., fixed logic circuitry), or any combination thereof. The terms “module,” “functionality,” “component”, “element”, “unit”, “block” and “logic” may be used herein to generally represent software, firmware, hardware, or any combination thereof. In the case of a software implementation, the module, functionality, component, element, unit, block or logic represents program code that performs the specified tasks when executed on a processor. The algorithms and methods described herein could be performed by one or more processors executing code that causes the processor(s) to perform the algorithms/methods. Examples of a computer-readable storage medium include a random-access memory (RAM), read-only memory (ROM), an optical disc, flash memory, hard disk memory, and other memory devices that may use magnetic, optical, and other techniques to store instructions or other data and that can be accessed by a machine.

The terms computer program code and computer readable instructions as used herein refer to any kind of executable code for processors, including code expressed in a machine language, an interpreted language or a scripting language. Executable code includes binary code, machine code, bytecode, code defining an integrated circuit (such as a hardware description language or netlist), and code expressed in a programming language code such as C, Java or OpenCL. Executable code may be, for example, any kind of software, firmware, script, module or library which, when suitably executed, processed, interpreted, compiled, executed at a virtual machine or other software environment, cause a processor of the computer system at which the executable code is supported to perform the tasks specified by the code.

A processor, computer, or computer system may be any kind of device, machine or dedicated circuit, or collection or portion thereof, with processing capability such that it can execute instructions. A processor may be any kind of general purpose or dedicated processor, such as a CPU, GPU, System-on-chip, state machine, media processor, an application-specific integrated circuit (ASIC), a programmable logic array, a field-programmable gate array (FPGA), or the like. A computer or computer system may comprise one or more processors.

It is also intended to encompass software which defines a configuration of hardware as described herein, such as HDL (hardware description language) software, as is used for designing integrated circuits, or for configuring programmable chips, to carry out desired functions. That is, there may be provided a computer readable storage medium having encoded thereon computer readable program code in the form of an integrated circuit definition dataset (which may also be referred to as a hardware design) that when processed (i.e. run) in an integrated circuit manufacturing system configures the system to manufacture a computing device comprising any apparatus described herein. An integrated circuit definition dataset may be, for example, an integrated circuit description.

Therefore, there may be provided a method of manufacturing, at an integrated circuit manufacturing system, a component for implementing a permutation respecting function as described herein. Furthermore, there may be provided an integrated circuit definition dataset that, when processed in an integrated circuit manufacturing system, causes the method of manufacturing a component implementing a permutation respecting function to be performed.

An integrated circuit definition dataset may be in the form of computer code, for example as a netlist, code for configuring a programmable chip, as a hardware description language defining hardware suitable for manufacture in an integrated circuit at any level, including as register transfer level (RTL) code, as high-level circuit representations such as Verilog or VHDL, and as low-level circuit representations such as OASIS® and GDSII. Higher level representations which logically define hardware suitable for manufacture in an integrated circuit (such as RTL) may be processed at a computer system configured for generating a manufacturing definition of an integrated circuit in the context of a software environment comprising definitions of circuit elements and rules for combining those elements in order to generate the manufacturing definition of an integrated circuit so defined by the representation. As is typically the case with software executing at a computer system so as to define a machine, one or more intermediate user steps (e.g. providing commands, variables etc.) may be required in order for a computer system configured for generating a manufacturing definition of an integrated circuit to execute code defining an integrated circuit so as to generate the manufacturing definition of that integrated circuit.

An example of processing an integrated circuit definition dataset (e.g. a hardware design) at an integrated circuit manufacturing system so as to configure the system to manufacture a component that implements a permutation respecting function will now be described with respect to FIG. 10.

FIG. 10 shows an example of an integrated circuit (IC) manufacturing system 1002 which is configured to manufacture a component that implements a permutation respecting function as described in any of the examples herein. In particular, the IC manufacturing system 1002 comprises a layout processing system 1004 and an integrated circuit generation system 1006. The IC manufacturing system 1002 is configured to receive an IC definition dataset/hardware design (e.g. defining a component that implements a permutation respecting function as described in any of the examples herein), process the IC definition dataset, and generate an IC according to the IC definition dataset (e.g. which embodies a component as described in any of the examples herein). The processing of the IC definition dataset configures the IC manufacturing system 1002 to manufacture an integrated circuit embodying a component implementing a permutation respecting function as described in any of the examples herein.

The layout processing system 1004 is configured to receive and process the IC definition dataset/hardware design to determine a circuit layout. Methods of determining a circuit layout from an IC definition dataset are known in the art, and for example may involve synthesising RTL code to determine a gate level representation of a circuit to be generated, e.g. in terms of logical components (e.g. NAND, NOR, AND, OR, MUX and FLIP-FLOP components). A circuit layout can be determined from the gate level representation of the circuit by determining positional information for the logical components. This may be done automatically or with user involvement in order to optimise the circuit layout. When the layout processing system 1004 has determined the circuit layout it may output a circuit layout definition to the IC generation system 1006. A circuit layout definition may be, for example, a circuit layout description.

The IC generation system 1006 generates an IC according to the circuit layout definition, as is known in the art. For example, the IC generation system 1006 may implement a semiconductor device fabrication process to generate the IC, which may involve a multiple-step sequence of photo lithographic and chemical processing steps during which electronic circuits are gradually created on a wafer made of semiconducting material. The circuit layout definition may be in the form of a mask which can be used in a lithographic process for generating an IC according to the circuit definition. Alternatively, the circuit layout definition provided to the IC generation system 1006 may be in the form of computer-readable code which the IC generation system 1006 can use to form a suitable mask for use in generating an IC.

The different processes performed by the IC manufacturing system 1002 may be implemented all in one location, e.g. by one party. Alternatively, the IC manufacturing system 1002 may be a distributed system such that some of the processes may be performed at different locations, and may be performed by different parties. For example, some of the stages of: (i) synthesising RTL code representing the IC definition dataset to form a gate level representation of a circuit to be generated, (ii) generating a circuit layout based on the gate level representation, (iii) forming a mask in accordance with the circuit layout, and (iv) fabricating an integrated circuit using the mask, may be performed in different locations and/or by different parties.

In other examples, processing of the integrated circuit definition dataset at an integrated circuit manufacturing system may configure the system to manufacture a component that implements a permutation respecting function without the IC definition dataset being processed so as to determine a circuit layout. For instance, an integrated circuit definition dataset may define the configuration of a reconfigurable processor, such as an FPGA, and the processing of that dataset may configure an IC manufacturing system to generate a reconfigurable processor having that defined configuration (e.g. by loading configuration data to the FPGA).

In some embodiments, an integrated circuit manufacturing definition dataset/hardware design, when processed in an integrated circuit manufacturing system, may cause an integrated circuit manufacturing system to generate a device as described herein. For example, the configuration of an integrated circuit manufacturing system in the manner described above with respect to FIG. 10 by an integrated circuit manufacturing definition dataset may cause a device as described herein to be manufactured.

In some examples, an integrated circuit definition dataset could include software which runs on hardware defined at the dataset or in combination with hardware defined at the dataset. In the example shown in FIG. 10, the IC generation system may further be configured by an integrated circuit definition dataset/hardware design to, on manufacturing an integrated circuit, load firmware onto that integrated circuit in accordance with program code defined at the integrated circuit definition dataset or otherwise provide program code with the integrated circuit for use with the integrated circuit.

The implementation of concepts set forth in this application in devices, apparatus, modules, and/or systems (as well as in methods implemented herein) may give rise to performance improvements when compared with known implementations. The performance improvements may include one or more of increased computational performance, reduced latency, increased throughput, and/or reduced power consumption. During manufacture of such devices, apparatus, modules, and systems (e.g. in integrated circuits) performance improvements can be traded-off against the physical implementation, thereby improving the method of manufacture. For example, a performance improvement may be traded against layout area, thereby matching the performance of a known implementation but using less silicon. This may be done, for example, by reusing functional blocks in a serialised fashion or sharing functional blocks between elements of the devices, apparatus, modules and/or systems. Conversely, concepts set forth in this application that give rise to improvements in the physical implementation of the devices, apparatus, modules, and systems (such as reduced silicon area) may be traded for improved performance. This may be done, for example, by manufacturing multiple instances of a module within a predefined area budget.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

What is claimed is:

1. A computer-implemented method of verifying that a hardware design for a component that implements a permutation respecting function is permutation respecting for a plurality of input vector permutations over all valid input vectors, the component being configured to receive an input vector comprising a plurality of input elements and generate an output based on the input vector and the function, the method comprising:
for each input vector permutation of the plurality of input vector permutations, verifying, at one or more processors, that the hardware design is permutation respecting for the input vector permutation by verifying that (i) an output of an instantiation of the hardware design in response to any input vector in a set of input vectors and (ii) an output of an instantiation of the hardware design in response to the input vector permutation of that input vector, are permutation related;
wherein the set of input vectors for each input vector permutation in a subset of the plurality of input vector permutations is selected based on an assumption that the hardware design is permutation respecting for at least one other input vector permutation of the plurality of input vector permutations.

2. The method of claim 1, further comprising identifying the set of input vectors for an input vector permutation of the subset by:
identifying a base set of input vectors from the input vector permutation of the subset and the at least one other input vector permutation;
identifying a permutation group formed from the input vector permutation of the subset and the at least one other input vector permutation;
forming an irreducible set of permutations that comprises the irreducible permutations in the permutation group; and
identifying the set of input vectors from the base set of input vectors and the irreducible set of permutations.

3. The method of claim 2, wherein identifying the base set of input vectors comprises, for each input vector permutation of a set of input vector permutations comprising the input vector permutation of the subset and the at least one other input vector permutation, constraining the base set of input vectors to input vectors in which two input elements have a predetermined relationship.

4. The method of claim 3, wherein each input vector permutation of the plurality of input vector permutation is an adjacent transposition that transposes two adjacent input elements, and identifying the base set of input vectors comprises, if an input vector permutation in the set transposes the i^{th} and (i+1)^{th} input elements, constraining the base set of input vectors to input vectors in which the i^{th} and (i+1)^{th} input elements have a predetermined relationship.

5. The method of claim 3, wherein the predetermined relationship is that the i^{th} and (i+1)^{th} input elements are in ascending order or that the i^{th} and (i+1)^{th} input elements are in descending order.

6. The method of claim 2, wherein a permutation \tilde{σ} is deemed to be reducible if (a) there exists a permutation σ′ in the permutation group that is equivalent to σᵥ\tilde{σ} where the length of σ′ is strictly less than the length of σᵥ\tilde{σ}, or (b) the length of σᵥ\tilde{σ} is strictly less than the length of \tilde{σ}, wherein σᵥ is the input vector permutation; and deemed irreducible otherwise.

7. The method of claim 2, wherein forming the irreducible set of permutations comprises:
determining whether each permutation in the permutation group is irreducible, and, in response to determining that a permutation in the permutation group is irreducible, adding the permutation to the irreducible set of permutations.

8. The method of claim 2, wherein forming the irreducible set of permutations comprises: (a) determining whether any of the at least one other input vector permutation is irreducible; (b) in response to determining that at least one of the at least one other input vector permutation is irreducible, adding each irreducible input vector permutation in the at least one other input vector permutation to the set of irreducible permutations; (c) adding each of the at least one other input vector permutation to each of the irreducible permutations added to the set of irreducible permutations to generate new permutations, determining if any of the new permutations are irreducible, and adding any new permutations that are irreducible to the set of irreducible permutations; and (d) repeating (c) if any new permutations have been added to the set of irreducible permutations.

9. The method of claim 1, wherein:
each of the plurality of input vector permutations is an adjacent transposition that transposes two adjacent input elements;
the subset of input vector permutations comprises the adjacent transposition that transposes the j^{th} and (j+1)^{th} input elements; and
the set of input vectors for the transposition that transposes the j^{th} and (j+1)^{th} input elements is not selected based on an assumption that the hardware design is permutation respecting for the adjacent transposition that transposes the (j+1)^{th} and (j+2)^{th} input elements and is not selected based on assumption that the hardware design is permutation respecting for the adjacent transposition that transposes the (j−1^{th}) and j^{th} input elements.

10. The method of claim 1, wherein:
each of the plurality of input vector permutations is an adjacent transposition that transposes two adjacent input elements;
the subset of input vector permutations comprises the adjacent transposition that transposes the j^{th} and (j+1)^{th} input elements; and
the set of input vectors for the transposition that transposes the j^{th} and (j+1)^{th} input elements is not selected based on an assumption that the hardware design is permutation respecting for the adjacent transposition that transposes the (j+2)^{th} and (j+3)^{th} input element and is not selected based on assumption that the hardware design is permutation respecting for the adjacent transposition that transposes the (j−2^{th}) and (j−1)^{th} input elements.

11. The method of claim 1, wherein:
each of the plurality of input vector permutations is an adjacent transposition that transposes two adjacent input elements;
the subset of input vector permutations comprises the adjacent transposition that transposes the j^{th} and (j+1)^{th} input elements; and
the set of input vectors for the transposition that transposes the j^{th} and (j+1)^{th} input elements is not selected based on an assumption that the hardware design is permutation respecting for the adjacent transposition that transposes the (j+1)^{th} and (j+2)^{th} input elements.

12. The method of claim 1, wherein:
each of the plurality of input vector permutations is an adjacent transposition that transposes adjacent input elements;
the subset of input vector permutations comprises the adjacent transposition that transposes the j^{th} and (j+1)^{th} input elements; and
the set of input vectors for the transposition that transposes the j^{th} and (j+1)^{th} input elements is not selected based on an assumption that the hardware design is permutation respecting for the adjacent transposition that transposes the (j−1)^{th} and j^{th} input elements.

13. The method of claim 1, wherein the subset of input vector permutations comprises a centre adjacent transposition that transposes the
$${( \frac{n}{2} - 1 )}^{th}$$
input element and the
$${( \frac{n}{2} )}^{th}$$
input element, and n is a number of input elements in the input vector.

14. The method of claim 13, wherein the plurality of input vector permutations comprises a generating set of adjacent permutations from which all input vector permutations can be generated, and the set of input vectors for the centre adjacent transposition is selected based on an assumption that the hardware design is permutation respecting for all or a subset of the other adjacent transpositions in the generating set.

15. The method of claim 1, wherein the output of an instantiation of the hardware design in response to a first input vector is permutation related to the output of the instantiation of the hardware design in response to a permutation of the first input vector if the output of the instantiation of the hardware design in response to the permuted input vector can be deduced solely from the output of the instantiation of the hardware design in response to the first input vector and the permutation.

16. The method of claim 1, wherein one or more of the verifications is performed via formal verification using a formal verification tool.

17. The method of claim 1, further comprising in response to the verifications being successful, (i) encoding on a computer readable storage medium the verified hardware design which, when processed in an integrated circuit manufacturing system, configures the integrated circuit manufacturing system to generate an integrated circuit embodying the design and/or (ii) manufacturing, using an integrated circuit manufacturing system, an integrated circuit embodying the component according to the hardware design.

18. A computer-implemented method of verifying the correctness of a hardware design for a component that implements a permutation respecting function, the component being configured to receive an input vector comprising a plurality of input elements and generate an output based on the input vector and the function, the method comprising:
verifying, at one or more processors, that the hardware design is permutation respecting for a plurality of input vector permutations for all valid input vectors by verifying that the hardware design is permutation respecting for a generating set of input vector permutations for the plurality of input vector permutations by:
for each input vector permutation in the generating set of input vector permutations, verifying, at the one or more processors, that the hardware design is permutation respecting for the input vector permutation by verifying that (i) an output of an instantiation of the hardware design in response to any input vector in a set of input vectors and (ii) an output of an instantiation of the hardware design in response to the input vector permutation of that input vector, are permutation related,
wherein the set of input vectors for each input vector permutation in a subset of the input vector permutations in the generating set of input vector permutations is selected based on an assumption that the hardware design is permutation respecting for at least one other input vector permutation in the generating set of input vector permutations; and
verifying, at the one or more processors, that an instantiation of the hardware design generates an expected output for each input vector of a subset of valid input vectors;
wherein each valid input vector that is not in the subset of valid input vectors can be obtained by applying one or more of the input vector permutations in the generating set of input vector permutations to an input vector in the subset.

19. A system for verifying a hardware design for a component that implements a permutation respecting function, the system comprising:
memory comprising:
the hardware design for a component that implements a permutation respecting function, the component configured to receive an input vector comprising a plurality of input elements and generate an output based on the input vector and the function, and
one or more verification tools; and
one or more processors configured to:
verify, using at least one of the verification tools, that the hardware design is permutation respecting for a plurality of input vector permutations for all valid input vectors by verifying that the hardware design is permutation respecting for a generating set of input vector permutations for the plurality of input vector permutations by:
for each input vector permutation in the generating set of input vector permutations, verifying that the hardware design is permutation respecting for the input vector permutation by verifying that (i) an output of an instantiation of the hardware design in response to any input vector in a set of input vectors and (ii) an output of an instantiation of the hardware design in response to the input vector permutation of that input vector, are permutation related,
wherein the set of input vectors for each input vector permutation in a subset of the input vector permutations in the generating set of input vector permutations is selected based on an assumption that the hardware design is permutation respecting for at least one other input vector permutation in the generating set of input vector permutations; and
verify, using at least one of the verification tools, that an instantiation of the hardware design generates an expected output for each input vector of a subset of valid input vectors;
wherein each valid input vector that is not in the subset of valid input vectors can be obtained by applying one or more of the input vector permutations in the generating set of input vector permutations to an input vector in the subset.

20. A non-transitory computer readable storage medium having stored thereon computer readable instructions that, when executed at a computer system, cause the computer system to perform the method as set forth in claim 1.
